(19) United States
(12) Patent Application Publication
(10) Pub. No.: US 2015/0215165 A1
(43) Pub. Date: Jul. 30, 2015

(54) MANAGEMENT DEVICE AND METHOD OF MANAGING CONFIGURATION INFORMATION OF NETWORK DEVICE

(71) Applicant: FUJITSU LIMITED, Kawasaki-shi (JP)

(72) Inventors: Kadohito Ohsuga, Numazu (JP); Naohiko Takamura, Fuji (JP); Hiroomi Aoyagi, Shizuoka (JP); Mayuko Morita, Yokohama (JP)

(73) Assignee: FUJITSU LIMITED, Kawasaki (JP)

(21) Appl. No.: 14/531,323

(22) Filed: Nov. 3, 2014

(30) Foreign Application Priority Data
Jan. 27, 2014 (JP) 2014-012543

(51) Int. Cl. H04L 12/24

(52) U.S. Cl. CPC H04L 41/0813; H04L 41/0859; H04L 41/0863

(57) ABSTRACT

A management device includes a storage unit and a processor. The processor is configured to store, when configuration information is updated by one client of a plurality of clients, the updated configuration information, generation information on a generation of the updated configuration information, and identification information of the one client in association with one another in the storage unit. The processor is configured to generate, when restoration to a first generation is requested by a first client, new configuration information with reference to information stored in the storage unit. The new configuration information does not include first contents of first updates made by the first client in second generations later than the first generation and includes second contents of second updates made in the second generations by second clients. The processor is configured to perform a configuration of a network device using the new configuration information.

### CROSS-REFERENCE TO RELATED APPLICATION

This application is based upon and claims the benefit of priority of the prior Japanese Patent Application No. 2014-012543, filed on Jan. 27, 2014, the entire contents of which are incorporated herein by reference.

### FIELD

The embodiments discussed herein are related to a management device and a method of managing configuration information of a network device.

### BACKGROUND

Various network devices controlling data transmission between devices are used. The network device is connected to an information processing device such as a computer or other network devices to form a network. Examples of network devices include an L2 switch that controls data transmission on a second layer of an Open Systems Interconnection (OSI) reference model and L3 switch and a router that control data transmission on a third layer thereof. Further, there is also a network device (for example, a firewall device or a load distribution device) that controls data transmission using one or more protocols in a layer that is equal to or higher than the second layer of the OSI reference model.

In the network device, configuration for controlling data transmission is performed. For example, a user performs a desired configuration by inputting a command (configuration command) indicating content of configuration to the network device. The content of configuration held in the network device may be collectively updated by inputting configuration information including a plurality of configuration commands to the network device. The configuration information corresponding to a current configuration may be acquired from the network device and may be used as a backup.

Configuration of a device may be returned to a past configuration. For example, after the configuration of a device is changed, when abnormality occurs in an operation of the device or a system including the device, the device or the system may be normalized by returning the configuration to a configuration in a normal state. Specifically, the following methods are proposed.

For example, a method has been proposed in which configuration information of a network device may be managed by generations, by combining groups of a plurality of devices instead of managing a single device. When a failure occurs, configuration information during a normal operation is distributed in units of device groups.

Another method has been proposed in which, when definition information set in an information processing device is restored from a current generation to a state of a previous generation, a reverse difference for restoration is generated, each subsystem (program) within the information processing device is notified of the reverse difference, and whether the definition information is to be restored may be determined by each subsystem.

Yet another method has been proposed in which configuration information of a virtual machine is recorded and, when the virtual machine fails, a new virtual machine is started using the configuration information.

Related techniques are disclosed in, for example, Japanese Laid-open Patent Publication No. 2010-278742, Japanese Laid-open Patent Publication No. 8-101763, and International Publication Pamphlet No. WO2011/117957.

A plurality of clients (for example, users or computers used by the users) may be allowed to change configuration of a network device. For example, there may be a service for renting, to a plurality of users, a computer or a resource of the network device within a data center. In such a service, each user may realize a desired system by using the rented resources. In this case, one network device may be shared among the plurality of users. For example, some of a plurality of ports for communication in the network device are used by a certain user, and some other ports thereof are used by another user. However, a network environment desired to be realized may differ from user to user. Therefore, for example, each user may be allowed to change a configuration of the ports used by the user.

However, in this case, restoration of the configuration becomes a problem. For example, in response to a request from a certain client, a past configuration of the network device may be restored. Past configuration information acquired as a backup may be input to the network device and the past configuration may be restored. However, configuration might have been changed by other clients after a time point in the past. Therefore, when the past configuration information is merely input to the network device in order to restore the configuration, change of configuration by other clients after the time point in the past may be invalidated.

### SUMMARY

According to an aspect of the present invention, provided is a management device including a storage unit and a processor. The processor is configured to store, when configuration information is updated by one client of a plurality of clients, the updated configuration information, generation information on a generation of the updated configuration information, and identification information of the one client in association with one another in the storage unit. The processor is configured to generate, when restoration to a first generation is requested by a first client of the plurality of clients, new configuration information with reference to information stored in the storage unit. The new configuration information does not include first contents of first updates made by the first client in second generations later than the first generation and includes second contents of second updates made in the second generations by second clients of the plurality of clients. The second clients are different from the first client. The processor is configured to perform a configuration of a network device using the new configuration information.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an information processing system of a first embodiment.

FIG. 2 is a diagram illustrating an information processing system of a second embodiment.

FIG. 3 is a diagram illustrating an exemplary hardware configuration of a management server.

FIG. 4 is a diagram illustrating an exemplary functional configuration of the management server.

FIG. 5 is a diagram illustrating an example of a configuration file group.

FIG. 6 is a diagram illustrating an example of a configuration file.

FIG. 7 is a diagram illustrating an example of a configuration file.

FIG. 8 is a diagram illustrating an example of a management table.

FIG. 9 is a diagram illustrating an example of a restriction table.

FIG. 10 is a diagram illustrating an example of a GUI.

FIG. 11 is a flowchart illustrating an example of a configuration changing process.

FIG. 12 is a flowchart illustrating an example of a restoration process.

FIG. 13 is a flowchart illustrating an example of a process (pattern_1) of generating a configuration file.

FIG. 14 is a flowchart illustrating an example of a process (pattern_2) of generating a configuration file.

FIG. 15 is a diagram illustrating a specific example of a process (pattern_1) of generating a configuration file.

FIG. 16 is a diagram illustrating a specific example of a process (pattern_1) of generating a configuration file.

FIG. 17 is a diagram illustrating a specific example of a process (pattern_2) of generating a configuration file.

FIG. 18 is a diagram illustrating a specific example of a process (pattern_2) of generating a configuration file.

FIG. 19 is a diagram illustrating another configuration example of a configuration file.

FIG. 20 is a diagram illustrating another configuration example of a configuration file.

FIG. 21 is a diagram illustrating an example of a network device.

FIG. 22 is a diagram illustrating a comparative example of a restoration process.

### DESCRIPTION OF EMBODIMENTS

Hereinafter, embodiments will be described with reference to the drawings.

First Embodiment

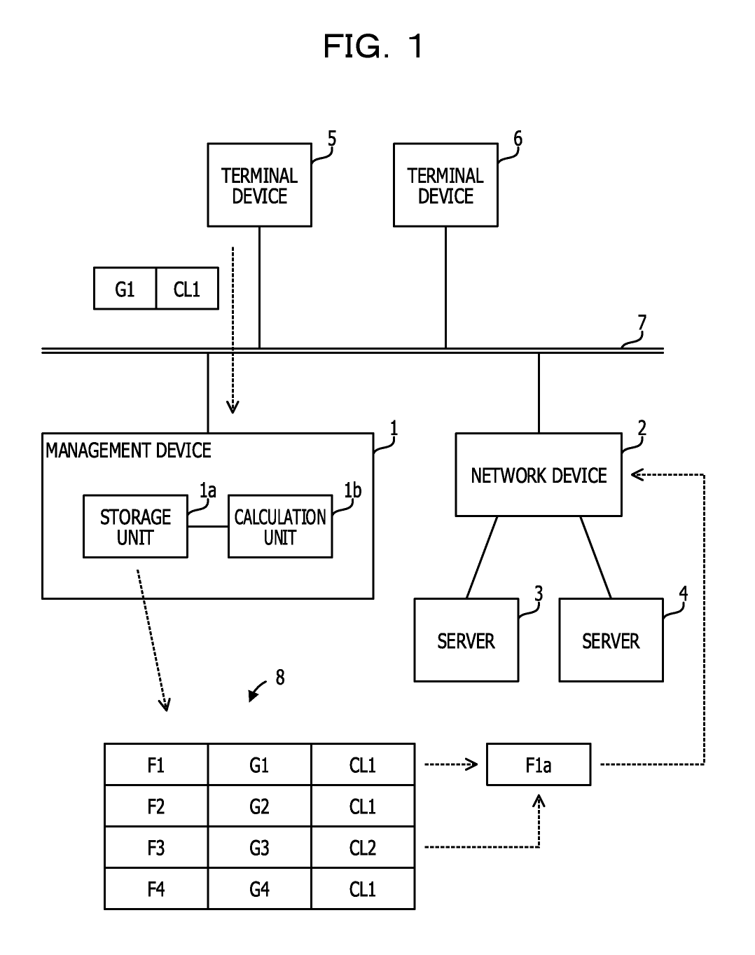

FIG. 1 is a diagram illustrating an information processing system of a first embodiment. The information processing system of the first embodiment includes a management device 1, a network device 2, servers 3 and 4, and terminal devices 5 and 6. The management device 1, the network device 2 and the terminal devices 5 and 6 are connected to a network 7. The servers 3 and 4 are connected to the network device 2.

The management device 1 manages configuration information used for configuration of the network device 2. The configuration information is information containing a plurality of commands (configuration commands) indicating contents (configuration contents) of configuration for the network device 2. The network device 2 relays communication between the servers 3 and 4 and the terminal devices 5 and 6. The network device 2 does not have a function of managing a change in configuration information for each user. The network device 2 holds current configuration information thereof as one file. The servers 3 and 4 are server computers that provide a service by a predetermined application. The terminal devices 5 and 6 are client computers operated by a user.

The server 3 is used by a user who operates the terminal device 5. The server 4 is used by a user who operates the terminal device 6. The servers 3 and 4 are under control of the network device 2. Therefore, the network device 2 is shared between the respective users who operate the terminal devices 5 and 6. Each of the users operating the terminal devices 5 and 6 performs configuration of the network device 2 through the management device 1. Therefore, configuration contents set by a plurality of users are contained in the configuration information of the network device 2.

The management device 1 allows each of the users operating the terminal devices 5 and 6 to change the configuration of the network device 2. For example, the management device 1 allows the user operating the terminal device 5 to change a configuration of the network device 2 with regard to a communication interface (communication port) connected to the server 3. Further, the management device 1 allows the user operating the terminal device 6 to change configuration of the network device 2 with regard to a port connected to the server 4. The management device 1 performs control so that the configuration performed by a certain user may not be changed by other users.

The management device 1, the network device 2, the servers 3 and 4, and the network 7 may be provided in a data center. The terminal devices 5 and 6 may access the network 7 within the data center over the Internet or the like. For example, there may be a service for renting a computer or resources of the network provided in the data center to a plurality of users. Even when a user using this service does not prepare a computer or a network, the user may realize a desired system using the rented resources within the data center. A user or a terminal device manipulated by the user may be referred to as a client. The client may be another device such as a server computer.

The management device 1 includes a storage unit is and a calculation unit lb. The storage unit is may be a volatile storage device such as a random access memory (RAM) or may be a non-volatile storage device such as a hard disk drive (HDD) or a flash memory. The calculation unit lb includes, for example, a processor. The processor may be a central processing unit (CPU) or a digital signal processor (DSP) or may be an electronic circuit having a specific use such as an application specific integrated circuit (ASIC) or a field programmable gate array (FPGA). The processor may be a multiprocessor composed of a plurality of processors. The processor may, for example, execute a program stored in the storage unit 1a.

The storage unit is stores therein configuration information updated by any one of a plurality of clients, the generation of the configuration information, and identification information of the client that has performed the update in association with one another. The identification information of the client may be identification information of the user or may be identification information of the terminal device operated by the user.

When the configuration information is updated by a client, the calculation unit lb acquires the updated configuration information, the generation of the updated configuration information, and the identification information of the client that has performed the update, and stores them in the storage unit is in association with one another. For example, the calculation unit lb acquires the updated configuration information from the network device 2. More specifically, the configuration information is managed as one file in the network device 2. The calculation unit lb acquires a file of the configuration information from the network device 2. The calculation unit lb generates information 8 indicating a correspondence relationship among the updated configuration information, the generation of the updated configuration information, and the identification information of the client, and stores the information 8 in the storage unit 1a.

The calculation unit 1b may receive an instruction to change the configuration from the terminal devices 5 and 6, and change the configuration of the network device 2 in accordance with the instruction. For example, the calculation unit lb may generate a configuration command in accordance with the instruction to change the configuration received from the terminal devices 5 and 6, and change the configuration of the network device 2 by inputting the configuration command to the network device 2. In this case, the calculation unit lb acquires the updated configuration information from the network device 2. Alternatively, the calculation unit lb may rewrite current configuration information of the network device 2 in accordance with the instruction to change the configuration received from the terminal devices 5 and 6, and may change the configuration of the network device 2 by inputting the rewritten configuration information to the network device 2. By inputting the configuration information to the network device 2, the calculation unit lb may collectively restore the configuration of the network device 2 at the point in time at which the configuration information is acquired.

If the configuration change is performed in accordance with the instruction received from the terminal device 5, the updated configuration information may be considered to be updated by the terminal device 5 or a user operating the terminal device 5. If the configuration change is performed in accordance with the instruction received from the terminal device 6, the updated configuration information may be considered to be updated by the terminal device 6 or a user operating the terminal device 6. Here, identification information of the terminal device 5 or the user operating the terminal device 5 is assumed to be identification information CL1. Identification information of the terminal device 6 or the user operating the terminal device 6 is assumed to be identification information CL2.

For example, the calculation unit lb changes the configuration of the network device 2 in accordance with an instruction received from the terminal device 5. Then, the updated configuration information F1, the generation G1 of the updated configuration information F1, and the identification information CL1 of the client that has performed the update are acquired and stored in the storage unit is in association with one another.

Subsequently, the calculation unit 1b changes the configuration of the network device 2 in accordance with an instruction received from the terminal device 5. Then, the updated configuration information F2, the generation G2 of the updated configuration information F2, and the identification information CL1 of the client that has performed the update are acquired and stored in the storage unit is in association with one another.

Subsequently, the calculation unit 1b changes the configuration of the network device 2 in accordance with an instruction received from the terminal device 6. Then, the updated configuration information F3 the generation G3 of the updated configuration information F3, and the identification information CL2 of the client that has performed the update are acquired and stored in the storage unit is in association with one another.

Further, the calculation unit 1b changes the configuration of the network device 2 in accordance with an instruction received from the terminal device 5. Then, the updated configuration information F4, the generation G4 of the updated configuration information F4, and the identification information CL1 of the client that has performed the update are acquired and stored in the storage unit is in association with one another. For example, correspondence relationships acquired in this way are sequentially registered as information 8.

The generation may be represented by information capable of identifying whether the configuration information is old or new. For example, the generation may be a time stamp, or may be a numerical value or a character string indicating the version. The generation may be an identifier (for example, a file name) of the configuration information as long as the identifier indicates whether the configuration information is old or new. In the example above, the generation G1 is the earliest, and the generation G4 is latest. The generation G2 is later than generation G1 and earlier than the generation G3. The generation G3 is later than the generation G2 and earlier than the generation G4.

The calculation unit 1b may identify the identification information of the client depending on a terminal device from which the instruction to change the configuration is received. When the identification information of the client is contained in the instruction to change the configuration, the calculation unit 1b may acquire the identification information contained in the instruction.

When restoration to a generation is requested by a client, the calculation unit 1b searches for contents of updates by other clients in the configuration information of generations later than the designated generation with reference to the acquired information (the information stored in the storage unit 1a).

For example, assume that restoration to generation G1 is requested by the terminal device 5. The calculation unit 1b may receive the identification information CL1 of the client together with the generation G1. For example, a user corresponding to the identification information CL1 may want to restore a past configuration of the generation G1. In this case, the user transmits an instruction to restore the configuration of the network device 2 to the management device 1 by operating the terminal device 5.

Then, the calculation unit 1b searches for contents of updates by other clients (clients other than the client having the identification information CL1) in configuration information F2, F3, and F4 of the generations G2, G3, and G4 which are later than the designated generation G1. In the above example, the configuration information F3 is changed by the client having identification information CL2. Thus, the calculation unit 1b acquires the content of update in the configuration information F3. For example, the calculation unit 1b may acquire the content of update in the generation G3 by the client having identification information CL2 by comparing the configuration information F2 with the configuration information F3 and detecting a difference between the configuration information F2 and the configuration information F3. Contents of updates include, for example, addition, update, and deletion of a configuration command.

By reflecting the searched contents of updates in first configuration information corresponding to the designated generation, the calculation unit 1b generates second configuration information to perform configuration of the network device 2 using the second configuration information. In this time, the calculation unit 1b does not reflect contents of updates by the client that has requested the restoration in the second configuration information.

For example, the calculation unit 1b generates configuration information F1a by reflecting the contents of updates by the client having the identification information CL2 and not reflecting the contents of updates by the client having the identification information CL1 in the configuration information F1 corresponding to the designated generation G1. Specifically, when it is found through the search that there is a configuration command which has been added by the client having the identification information CL2, the configuration command is added to the configuration information F2. If there is an updated configuration command, the configuration command contained in the configuration information F1 is similarly updated. If there is a deleted configuration command, the configuration command is deleted from the configuration information F1. If there are a plurality of contents of updates by the client having identification information CL2, the contents of updates are reflected sequentially in the configuration information F1 from the content of update of the earlier generation.

The calculation unit 1b performs the configuration of the network device 2 using the generated configuration information F1a. For example, the calculation unit 1b may perform the configuration of the network device 2 by inputting the configuration information F1a to the network device 2 and causing the network device 2 to execute the configuration command contained in the configuration information F1a.

According to the management device 1, when restoration to a generation is requested by a client, the calculation unit 1b refers to the storage unit la to search for contents of updates by other clients in the configuration information of generations later than the designated generation. By reflecting the contents of updates in the first configuration information corresponding to the designated generation, the calculation unit 1b generates second configuration information. The calculation unit 1b performs configuration of the network device 2 using the second configuration information. Accordingly, even when the configuration by a certain client is restored, configurations by other clients may be maintained. Details are as follows.

For example, when the configuration of the past generation G1 of the network device 2 is restored in response to a request from a client having the identification information CL1, the configuration information F1 may be input to the network device 2 to restore the configuration of the generation G1. However, in the above example, in the generation G3 which is later than the generation G1 of the configuration information F1, a configuration change of the network device 2 is performed by the client having the identification information CL2. Therefore, when the configuration information F1 is input to the network device 2 to restore the configuration, the configuration change corresponding to the generation G3 is invalidated. In other words, the configuration contents of the generation G3 by the client having the identification information CL2 is nullified in the network device 2. When the configuration of the network device 2 is different from the configuration intended by the user operating the terminal device 6, problems may be posed for the use of the server 4 by the user.

On the other hand, the configuration of the network device 2 may be restored by inputting the configuration information F3 of the generation G3 to the network device 2. This is because the configuration by the client having the identification information CL2 may be maintained. However, a configuration change in the generation G2 by the client having the identification information CL1 is reflected in the configuration information F3. Therefore, even when the configuration information F3 is input to the network device 2, the requested configuration (the configuration of the generation G1) may not be restored.

Thus, even when any of the configuration information F1, the configuration information F2, the configuration information F3, and the configuration information F4 acquired as backups in the storage unit 1a is input to the network device 2, it is difficult to return to the configuration of the generation G1 with respect only to the configuration by the client having the identification information CL1.

Therefore, according to the management device 1, the configuration information F1a is generated as described above. The configuration information F1a contains the configuration corresponding to the generation G1 by the client having identification information CL1, and also contains the configuration corresponding to generation G3 by the client having identification information CL2. Thus, when the configuration information F1a is input to the network device 2 and set, the configuration at the time of the generation G1 is restored for the client having the identification information CL1, and the configuration at the time of the generation G3 is maintained for the client having the identification information CL2. Thus, the management device 1 may maintain the configurations by other clients when a configuration by a certain client is restored.

Second Embodiment

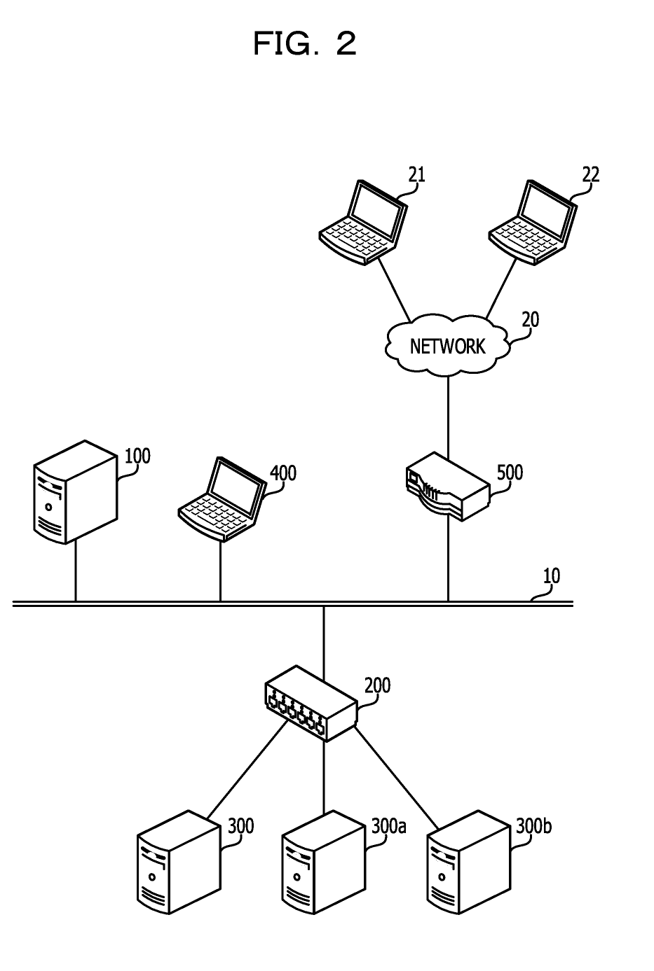

FIG. 2 is a diagram illustrating an information processing system of a second embodiment. The information processing system of the second embodiment includes a management server 100, an L2 switch 200, servers 300, 300a, and 300b, a terminal device 400, and a router 500. The management server 100, the L2 switch 200, the servers 300, 300a, and 300b, the terminal device 400, and the router 500 are provided in a data center and connected to a network 10.

The network 10 is a local area network (LAN) in the data center. The servers 300, 300a, and 300b are connected to the L2 switch 200. The router 500 is connected to a network 20. The network 20 is an extensive network, such as a wide area network (WAN) or the Internet.

A business operator of this information processing system rents resources of the server computer and the network device in the data center to a plurality of users. The user who is a borrower may be referred to as a tenant. The tenant may be, for example, an organization such as a company or a department in the company or may be an individual. Each tenant may access the network 10 over the network 20 using a terminal of the tenant and use the server computer or a network device in the data center. This form of using the computer may be called cloud computing.

In the second embodiment, the network device is assumed not to have a function of managing a change of the configuration file for each tenant. Here, the configuration file is information containing a command (a configuration command) indicating content of configuration for the network device. The configuration file may be called configuration information.

Terminal devices 21 and 22 are connected to the network 20. The terminal device 21 is a client computer used by tenant A. The terminal device 22 is a client computer used by tenant B. The tenant or the terminal device used by the tenant may be referred to as a client. Tenants A and B may be assigned resources of the L2 switch 200 and the servers 300, 300a, and 300b, and use at least some of the resources of each device.

For example, communication interfaces (communication ports) included in the L2 switch 200 are the resources of the L2 switch 200. For example, processors and RAMs included in the servers 300, 300a, and 300b are the resources of the servers 300, 300a, and 300b. A plurality of virtual machines using the resources of the servers 300, 300a, and 300b may be operated and resource assignment to tenants A and B may be performed in units of virtual machines. Even when tenants A and B do not prepare their own server computer or network, tenants A and B may realize a desired system using the borrowed resources.

The management server 100 is a server computer that manages changes in the configurations of the L2 switch 200 and the servers 300, 300a, and 300b by tenants A and B. The management server 100 provides a graphical user interface (GUI) for operation and management to tenants A and B or an administrator of the information processing system. For example, the management server 100 may have a web server function and provide a GUI to a web browser operating in the terminal devices 21, 22, and 400.

The L2 switch 200 is a network device shared by tenants A and B. The L2 switch 200 includes a plurality of ports. Some of the plurality of ports are assigned to tenant A, and some other ports thereof are assigned to tenant B. Tenants A and B may log in to the management server 100 using the terminal devices 21 and 22 and use the GUI provided by the management server 100. For example, the tenants A and B may operate the GUI and change the configuration of the L2 switch 200 in accordance with a network environment desired to be realized.

The servers 300, 300a, and 300b are server computers used by tenants A and B. For example, tenants A and B may install and use a predetermined application program in the servers 300, 300a, and 300b (or virtual machines operating on the servers 300, 300a, and 300b). Management of resource assignment for the servers 300, 300a, and 300b or management of installation of the application program, for example, may be performed by the management server 100.

The terminal device 400 is a client computer used by the administrator managing the information processing system. The administrator logs in to the management server 100 using the terminal device 400, and may use the GUI provided by the management server 100. For example, the administrator operates the GUI and performs a predetermined configuration of the L2 switch 200.

The router 500 is a network device connecting the networks 10 and 20. The management server 100 is one example of the management device 1 in the first embodiment. The L2 switch 200 is one example of the network device 2 in the first embodiment.

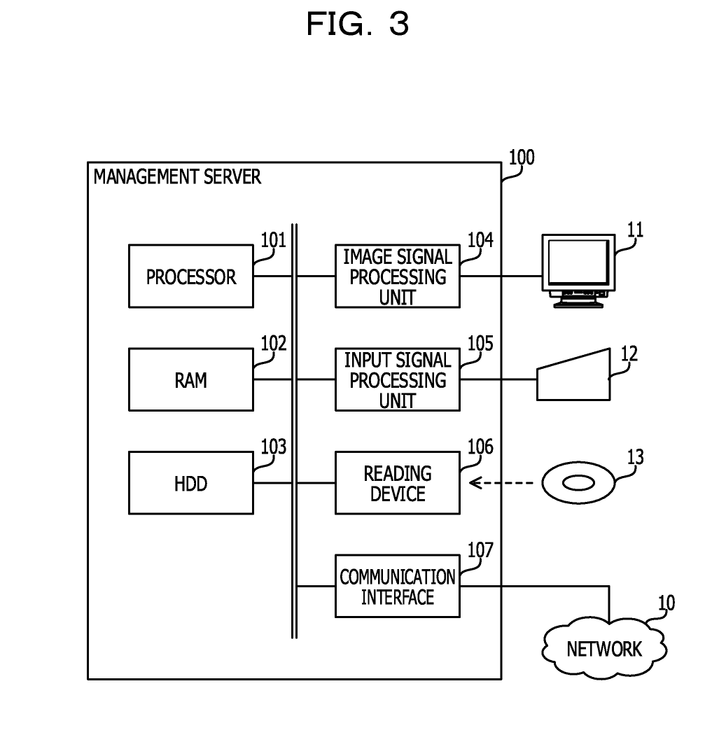

FIG. 3 is a diagram illustrating an exemplary hardware configuration of the management server. The management server 100 includes a processor 101, a RAM 102, an HDD 103, an image signal processing unit 104, an input signal processing unit 105, a reading device 106, and a communication interface 107. Each unit is connected to a bus of the management server 100.

The processor 101 controls the entire management server 100. The processor 101 may be a multiprocessor. The processor 101 is, for example, a CPU, a DSP, an ASIC, or an FPGA. The processor 101 may be a combination of two or more of the CPU, the DSP, the ASIC, and the FPGA.

The RAM 102 is a main storage device of the management server 100. The RAM 102 temporarily stores at least a part of a program of an operating system (OS) or an application program executed by the processor 101. Further, the RAM 102 stores various data used for a process in the processor 101.

The HDD 103 is an auxiliary storage device of the management server 100. The HDD 103 magnetically performs writing and reading of data to and from a built-in magnetic disk. A program of an OS, an application program, and various data are stored in the HDD 103. The management server 100 may include other types of auxiliary storage devices such as a flash memory or a solid state drive (SSD) or may include a plurality of auxiliary storage devices.

The image signal processing unit 104 outputs an image to a display 11 connected to the management server 100 in accordance with a command from the processor 101. Various displays including a cathode ray tube (CRT) display, a liquid crystal display (LCD), and an organic electro-luminescence display may be used as the display 11.

The input signal processing unit 105 acquires an input signal from an input device 12 connected to the management server 100, and outputs the input signal to the processor 101. Various input devices including a pointing device such as a mouse or a touch panel, and a keyboard may be used as the input device 12. Plural types of input devices may be connected to the management server 100.

The reading device 106 is a device that reads a program or data recorded in a recording medium 13. A magnetic disk such as a flexible disk (FD) or an HDD, an optical disc such as a compact disc (CD) or a digital versatile disc (DVD), or a magneto-optical disk (MO), for example, may be used as the recording medium 13. Further, a non-volatile semiconductor memory such as a flash memory card, for example, may be used as the recording medium 13. The reading device 106, for example, stores a program or data read from the recording medium 13 in the RAM 102 or the HDD 103 in accordance with a command received from the processor 101.

The communication interface 107 performs communication with other devices (for example, the terminal devices 21, 22, and 400 and the L2 switch 200) over the network 10. The communication interface 107 may be a wired communication interface or may be a wireless communication interface.

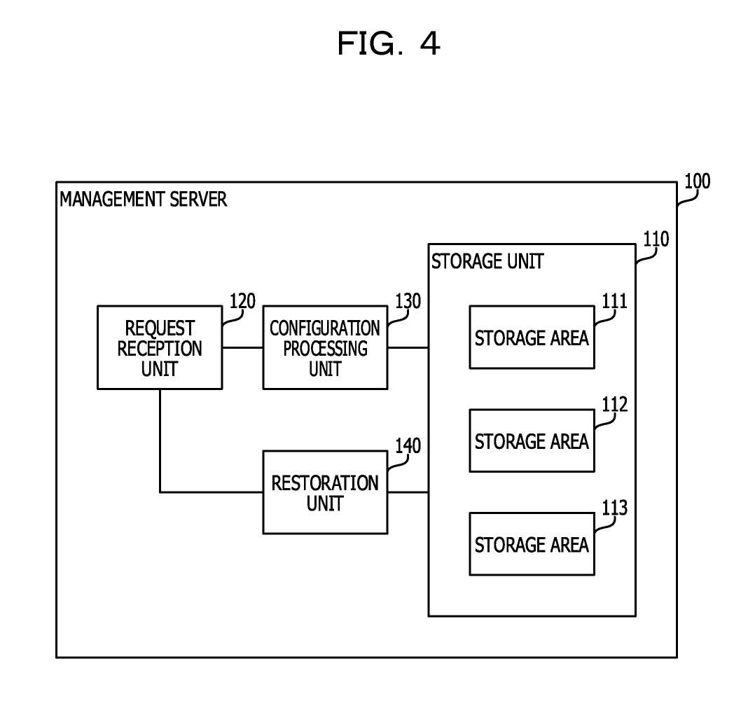

FIG. 4 is a diagram illustrating an exemplary functional configuration of the management server. The management server 100 includes a storage unit 110, a request reception unit 120, a configuration processing unit 130, and a restoration unit 140. The storage unit 110 may be realized using an area secured in the HDD 103. The request reception unit 120, the configuration processing unit 130, and the restoration unit 140 may be realized by the processor 101 executing a module of the program.

The storage unit 110 stores therein information used for a process of each unit. The information stored in the storage unit 110 contains a configuration file group, information of a management table, and information of a restriction table.

The configuration file group stored in a storage area 111 is a set of configuration files indicating contents of configuration of the L2 switch 200. The management table stored in a storage area 112 is information used for management of the generations of the configuration file group. The restriction table stored in a storage area 113 is information indicating restrictions of the configuration of the L2 switch 200.

The storage unit 110 may store therein the information of the configuration file group, the management table, and the restriction table for each network device that is a configuration target of the management server 100. For example, when a network device other than the L2 switch 200 is a configuration target, the storage unit 110 stores the information of the configuration file group, the management table, and the restriction table for the network device.

The request reception unit 120 receives a request (configuration request) to perform the configuration of the L2 switch 200 or a request (restoration request) to restore the configuration of the L2 switch 200 from the terminal devices 21, 22, and 400. When the request reception unit 120 receives a request for a configuration of the L2 switch 200, the request reception unit 120 instructs the configuration processing unit 130 to change the configuration of the L2 switch 200 in accordance with the configuration request. The configuration request contains identification information (tenant identifier (ID)) of the tenant which is a request source, and content of the configuration change. The tenant ID may be an ID for identifying the tenant or may be identification information of the terminal device used by the tenant.

When the request reception unit 120 receives a request to restore the L2 switch 200, the request reception unit 120 instructs the restoration unit 140 to execute a restoration process. The restoration request contains the tenant ID of the request source and a generation of a configuration to be restored.

The configuration processing unit 130 changes the configuration of the L2 switch 200 in accordance with the configuration request. Specifically, the configuration processing unit 130 generates a configuration command in accordance with the content of the requested configuration change and inputs the configuration command to the L2 switch 200. For example, the configuration processing unit 130 may input the configuration command to the L2 switch 200 using a protocol such as a Telecommunication Network (Telnet) or Secure Shell (SSH). Then, the configuration command is executed by the L2 switch 200, and the configuration of the L2 switch 200 is changed.

The configuration processing unit 130 acquires the configuration file after the change from the L2 switch 200 as a backup when performing the configuration change of the L2 switch 200. The configuration processing unit 130 may acquire the configuration file each time the configuration change of the L2 switch 200 is performed, or may acquire the configuration file each time the configuration change is performed several times. The configuration processing unit 130, for example, may acquire the configuration file from the L2 switch 200 using a protocol such as a file transfer protocol (FTP), a trivial FTP (TFTP), and a secure copy (SCP).

The configuration processing unit 130 stores the acquired configuration file in the storage unit 110 (adds the acquired configuration file to the configuration file group). The configuration processing unit 130 registers a correspondence relationship among a file name of the newly stored configuration file, the generation thereof, and the tenant ID of a configuration request source in the management table.

The restoration unit 140 restores the configuration of the L2 switch 200 to a configuration of a designated generation in accordance with the restoration request. The restoration may be called rollback. Specifically, the restoration unit 140 searches for contents of updates by tenants other than the restoration request source or by the administrator in the configuration file of the generations later than the generation designated by the restoration request. The restoration unit 140 generates a configuration file for configuration restoration by reflecting the contents of updates in the configuration file corresponding to the designated generation. The restoration unit 140 inputs the generated configuration file to the L2 switch 200 to perform the configuration of the L2 switch 200. The restoration unit 140, for example, may input the generated configuration file to the L2 switch 200 using a protocol such as an FTP, a TFTP, or an SCP.

In this time, the restoration unit 140 checks whether the newly generated configuration file satisfies the restrictions of the configuration of the L2 switch 200 with reference to a restriction table. If the configuration file satisfies the restrictions, the restoration unit 140 inputs the configuration file to the L2 switch 200. If the configuration file does not satisfy the restrictions, the restoration unit 140 notifies the tenant who has transmitted the restoration request of a configuration error.

When the configuration file is input, the L2 switch 200 executes the configuration commands contained in the configuration file and collectively updates the configuration contents held in the RAM included in the L2 switch. Further, for example, the L2 switch 200 writes the configuration file to a non-volatile memory (NVRAM) included in the L2 switch and uses the configuration file for a configuration upon reloading the configuration file to the RAM or upon turning on the power again. The configuration processing unit 130 may input a predetermined command for performing these processes to the L2 switch 200 together with the configuration file. When the past configuration file is held in the storage unit 110, the past configuration of the L2 switch 200 may be restored using the configuration file. Therefore, the configuration file included in the configuration file group may be called a backup file.

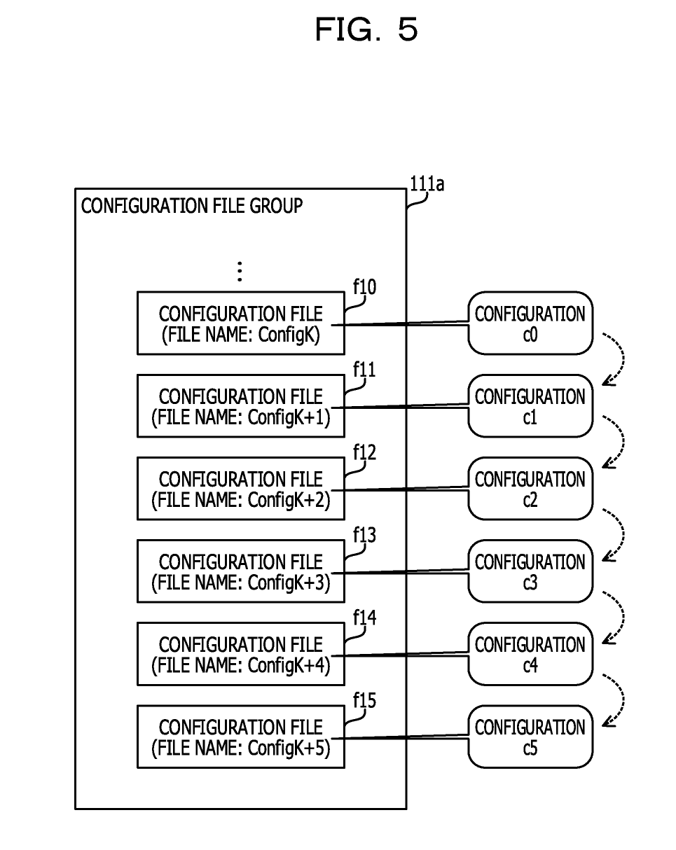

FIG. 5 is a diagram illustrating an example of the configuration file group. A configuration file group 111a includes configuration files f10, f11, f12, f13, f14, and f15 for the L2 switch 200. The configuration files f10, f11, f12, f13, f14, and f15 are configured in this order. The configuration file f15 is a configuration file of the latest generation at this time point. Configuration files of earlier generations (previous generations) than the configuration file f10 are not illustrated.

A file name of the configuration file f10 is “ConfigK”. The “K” following a character string “Config” corresponds to the generation. For example, the configuration file f10 contains a configuration c0. Configuration c0 indicates one or more configuration commands. A configuration c1 indicates a difference, such as addition, update, and deletion of one or more configuration commands, in the content of the configuration from the configuration file f10. Subsequent configurations c2, c3, c4, and c5 indicate a difference in the content of the configuration from an immediately preceding configuration file like the configuration c1.

A file name of the configuration file f11 is “ConfigK+1”. The character string “K+1” indicates a configuration file of a first generation after the generation K of “ConfigK”. The same applies to “K+2” (a second generation after the generation K) and “K+3” (a third generation after the generation K) illustrated below. For example, the configuration file f11 has a difference of the configuration c1 from the configuration file f10.

A file name of the configuration file f12 is “ConfigK+2”. The configuration file f12 has a difference of a configuration c2 from the configuration file f11. A file name of the configuration file f13 is “ConfigK+3”. The configuration file f13 has a difference of the configuration c3 from the configuration file f12. A file name of the configuration file f14 is “ConfigK+4”. The configuration file f14 has a difference of a configuration c4 from the configuration file f13. A file name of the configuration file f15 is “ConfigK+5”. The configuration file f15 has a difference of the configuration c5 from the configuration file f14.

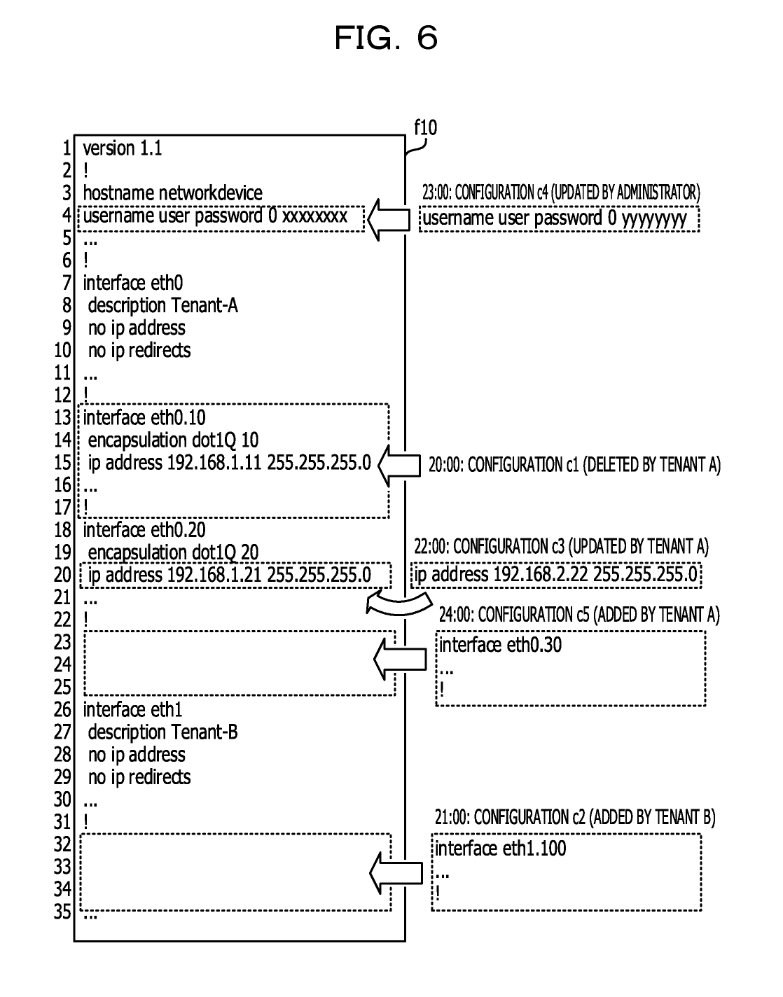

FIG. 6 is a diagram illustrating an example of a configuration file. The configuration file f10 is illustrated in FIG. 6. The configuration contents of the configuration file f10 illustrated in FIG. 6 may be considered as the configuration c0 illustrated in FIG. 5. Hereinafter, the configuration contents of the configuration file f10 is indicated by a line number illustrated in FIG. 6. For example, the configuration file of the L2 switch 200 is changed as follows in accordance with a configuration change of the L2 switch 200 by tenants A and B and the administrator.

At 20:00, a configuration of a thirteenth line to a seventeenth line is deleted by tenant A. This configuration is deletion of a virtual LAN (VLAN) interface for a predetermined port assigned to tenant A. This configuration corresponds to the configuration c1 (a difference between the configuration file f11 and the configuration file f10) illustrated in FIG. 5. The configuration file f11 corresponds to a configuration file after the deletion from the configuration file f10 has been performed.

At 21:00, a configuration is added to a 32nd line to a 34th line by tenant B. This configuration is addition of a VLAN interface for a predetermined port assigned to tenant B. This configuration corresponds to the configuration c2 (a difference between the configuration file f11 and the configuration file f12) illustrated in FIG. 5. The configuration file f12 corresponds to a configuration file after the addition to the configuration file f11 has been performed.

At 22:00, a configuration in a 20th line is updated by tenant A. This configuration is an update of an Internet protocol (IP) address in the VLAN interface of tenant A. This configuration corresponds to the configuration c3 (a difference between the configuration file f12 and the configuration file f13) illustrated in FIG. 5. The configuration file f13 corresponds to a configuration file after the update has been performed on the configuration file f12.

At 23:00, a configuration in a fourth line is updated by the administrator. This configuration is update of a password that has been set for the L2 switch 200. This configuration corresponds to the configuration c4 (a difference between the configuration file f13 and the configuration file f14) illustrated in FIG. 5. The configuration file f14 corresponds to a configuration file after the update has been performed on the configuration file f13.

At 24:00, a configuration of a 23rd line to a 25th line is added by tenant A. This configuration is addition of a VLAN interface for a predetermined port assigned to tenant A. This configuration corresponds to the configuration c5 (a difference between the configuration file f14 and the configuration file f15) illustrated in FIG. 5. The configuration file f15 corresponds to a configuration file after the addition to the configuration file f14 has been performed.

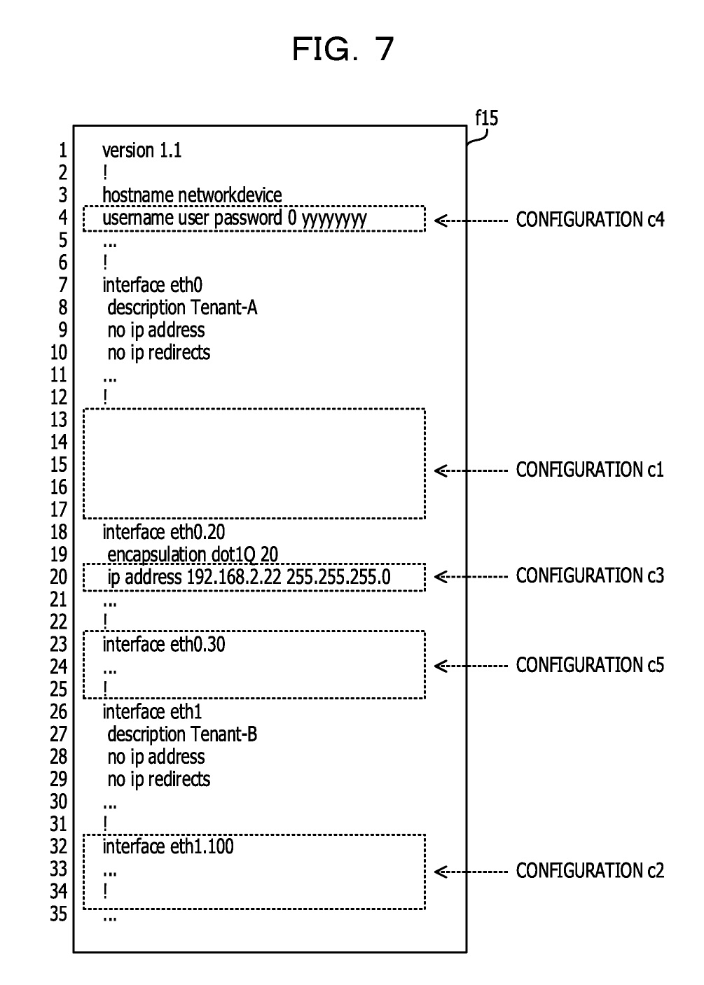

FIG. 7 is a diagram illustrating an example of a configuration file. The configuration file f15 is illustrated in FIG. 7. The configuration file f15 is a configuration file after the configurations c1, c2, c3, c4, and c5 are performed on the configuration file f10, as illustrated in FIG. 6.

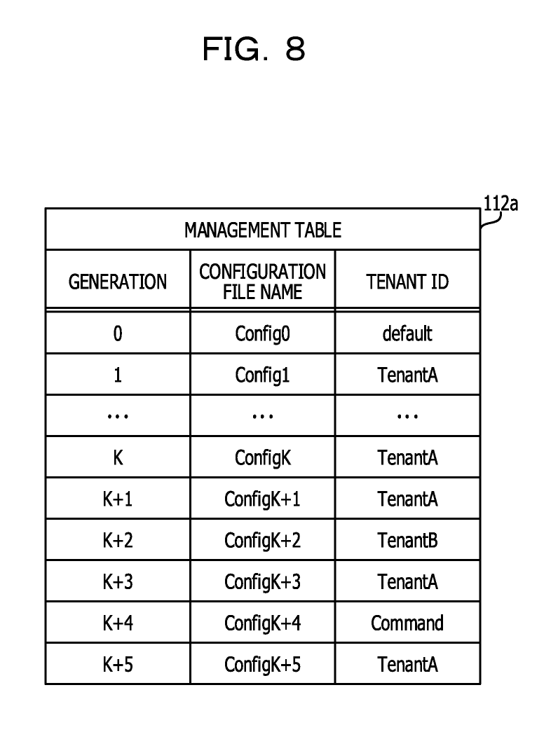

FIG. 8 is a diagram illustrating an example of a management table. A management table 112a includes items of a generation, a configuration file name, and a tenant ID. The generation of the configuration file is registered with the item of the generation. Here, for example, a numerical value is used as the generation. Smaller numerical values indicate earlier generations and larger values indicate later generations. Other information capable of identifying old or new, such as a time stamp, may be used as the generation. A file name of a configuration file is registered with the item of the configuration file name. A tenant ID is registered with the item of the tenant ID. Information such as “default” indicating a default configuration (initial configuration immediately after an operation of the information processing system starts) or “command” indicating that a configuration change is performed by the administrator may be registered with the item of the tenant ID.

For example, information indicating that the generation is “0”, the configuration file name is “Config0”, and the tenant ID is “default” is registered in the management table 112a. This indicates that the configuration file indicated by the file name “Config0” is a default configuration. A changed part of the next generation may be extracted by storing the default configuration.

Information indicating that the generation is “K”, the configuration file name is “ConfigK”, and the tenant ID is “TenantA” (tenant ID of tenant A) is registered in the management table 112a. This indicates that the file name of the configuration file f10 of the generation K is “ConfigK”, and the configuration file f10 is acquired with the configuration change by tenant A.

Information indicating that the generation is “K+2”, the configuration file name is “ConfigK+2”, and the tenant ID is “TenantB” (tenant ID of tenant B) is registered in the management table 112a. This indicates that the file name of the configuration file f12 of the generation K+2 is “ConfigK+2”, and the configuration file f12 is acquired with the configuration change by tenant B.

Information indicating that the generation is “K+4”, the configuration file name is “ConfigK+4”, and the tenant ID is “command” is registered in the management table 112a. This indicates that a file name of the configuration file f14 of the generation K+4 is “ConfigK+4”, and the configuration file f14 is acquired with the configuration change by the administrator. Information on the other configuration files is similarly registered in the management table 112a.

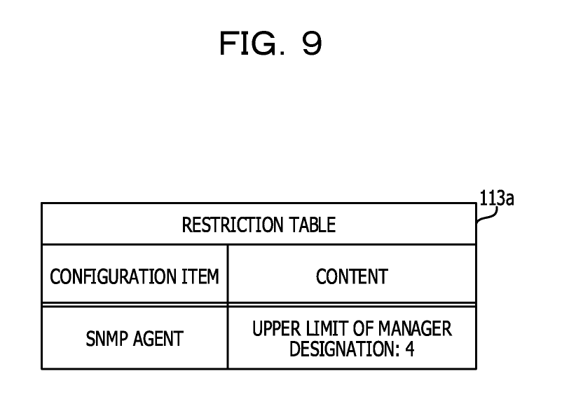

FIG. 9 is a diagram illustrating an example of a restriction table. A restriction table 113a includes items of a configuration item and content. A name of the configuration item with a restriction is registered with the item of the configuration item. Content of the restriction is registered with the item of content.

For example, information indicating that the configuration item is “Simple Network Management Protocol (SNMP) agent”, and the content is “upper limit of manager designation: 4” is registered in the restriction table 113a. This indicates that, when SNMP managers to which SNMP traps and the like are transmitted are designated for an SNMP agent operating on the L2 switch 200, an upper limit of the number of designated SNMP managers is 4.

Various restrictions depending on the network device may be registered with the restriction table 113a, in addition to the above items. For example, when the number of IP addresses or VLAN interfaces used by each tenant is limited, an upper limit of the number of IP addresses or VLAN interfaces for each tenant may be registered with the restriction table 113a.

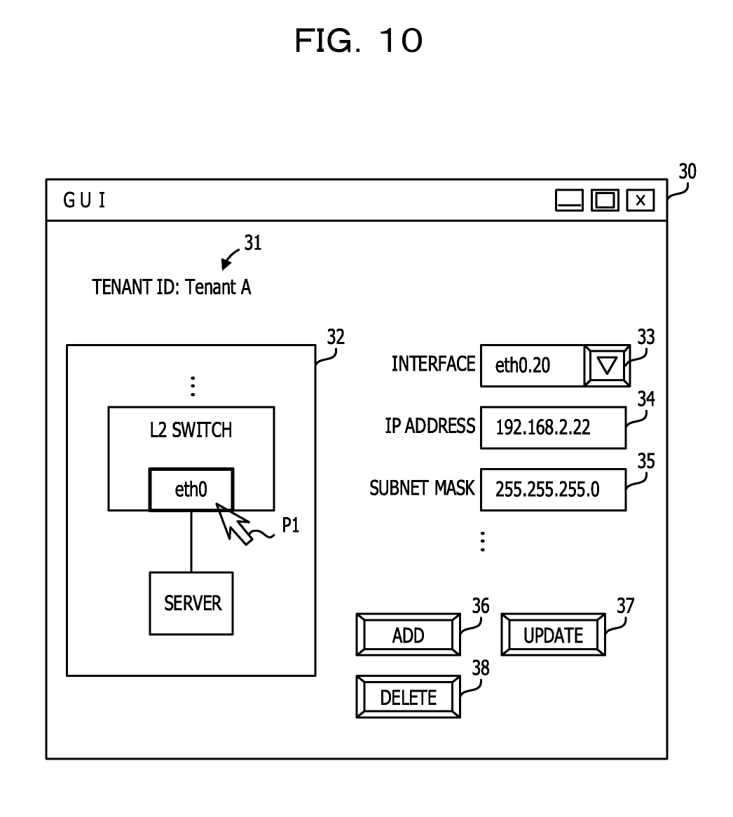

FIG. 10 is a diagram illustrating an example of a GUI. A GUI 30 is provided to the terminal devices 21, 22, and 400 by the management server 100. A case in which tenant A changes the configuration of the L2 switch 200 is illustrated in FIG. 10. For example, tenant A operates the terminal device 21 to log in to the management server 100. Tenant A selects resource configuration change from among a predetermined menu displayed on a display of the terminal device 21. Then, the GUI 30 is displayed on the display of the terminal device 21. The GUI 30 includes a display form 31, an image area 32, configuration forms 33, 34, and 35, and buttons 36, 37, and 38.

The display form 31 is a form in which the tenant ID of the logged-in tenant A is displayed. The image area 32 is an area in which devices and parts in the devices of which the configuration may be changed by tenant A. For example, an image indicating the L2 switch 200 and a port assigned to tenant A in the L2 switch 200 is displayed in the image area 32. Tenant A may operate a pointer P1 using a pointing device such as a mouse connected to the terminal device 21, and select an image for which the configuration is desired to be added, updated or deleted. For example, when a predetermined port (port name “eth0”) of the L2 switch 200 of which the configuration may be changed by tenant A is selected, the configuration contents of the port are displayed in the configuration forms 33, 34, and 35.

The configuration forms 33, 34, and 35 are forms in which the configuration contents regarding the selected port is displayed and to which a configuration after the change is input. For example, the following information is displayed for the port selected in the image area 32. Identification information “eth0.20” of the VLAN interface set for the port is displayed in the configuration form 33. An IP address of the VLAN interface is displayed in the configuration form 34. A subnet mask of an IP address is displayed in the configuration form 35. If a plurality of VLAN interfaces are set, a pull-down button of the configuration form 33 may be selected to display identification information of the plurality of the VLAN interfaces, and the display of the configuration forms 33, 34, and 35 may be changed by selecting any piece of the identification information.

The buttons 36, 37, and 38 are buttons for transmitting a configuration request from the terminal device 21 to the management server 100. Specifically, the button 36 is a button for adding a configuration for the selected port. For example, tenant A may request the management server 100 to add a new configuration by inputting information on a new VLAN interface to the configuration forms 33, 34, and 35 and pressing the button 36 using the pointer P1.

The button 37 is a button for updating a configuration for the selected port. For example, tenant A may request the management server 100 to update an existing configuration by updating the information displayed in the configuration forms 33, 34, and 35 and pressing the button 37 using the pointer P1.

The button 38 is a button for deleting a configuration for the selected port. For example, tenant A may request the management server 100 to delete the configuration of any VLAN interface by pressing the button 38 using pointer P1 in a state in which information of the VLAN interface is displayed in the configuration forms 33, 34, and 35.

Thus, when tenant A logs in, the management server 100 provides tenant A with the GUI 30 including only items that may be set by tenant A and thereby suppresses the change of the configurations for resources assigned to other tenants by tenant A. The management server 100 holds information indicating configurations allowed for each tenant in advance. Accordingly, for example, an operation of other tenants deleting or changing content set by a certain tenant (for example, an operation of tenant A adding a VLAN number “15” to a certain port and then tenant B deleting the VLAN number “15”) is restricted.

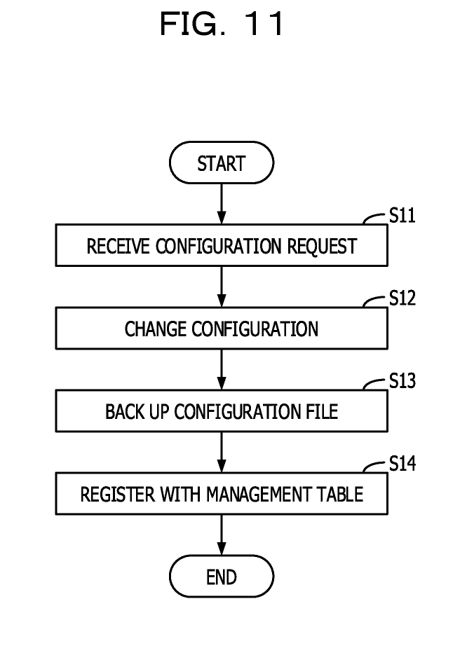

FIG. 11 is a flowchart illustrating an example of a configuration changing process. Hereinafter, the process illustrated in FIG. 11 will be described.

(S11) The request reception unit 120 receives a configuration request for the L2 switch 200 from a terminal device. The configuration request contains a tenant ID of a request source, and content of a configuration change. The request reception unit 120 instructs the configuration processing unit 130 to change the configuration of the L2 switch 200.

(S12) The configuration processing unit 130 generates a configuration command in accordance with the content of the configuration change and inputs the configuration command to the L2 switch 200. For example, the configuration processing unit 130 may input the configuration command to the L2 switch 200 using a protocol such as Telnet so that the configuration command may be executed. The L2 switch 200 executes the configuration command and changes the content of configuration held in the L2 switch 200.

(S13) The configuration processing unit 130 acquires a configuration file after the configuration change from the L2 switch 200. For example, the configuration processing unit 130 may acquire the configuration file from the L2 switch 200 using a protocol such as a TFTP. The configuration processing unit 130 stores the acquired configuration file in the storage unit 110. In this time, the configuration processing unit 130 assigns a file name and a generation to the newly stored configuration file. Here, a numerical value (0, 1, 2, . . . ) may be assigned as the generation. The configuration processing unit 130 may assign a name corresponding to the generation as the file name.

(S14) The configuration processing unit 130 registers a correspondence relationship among the file name of the newly acquired configuration file, the generation, and the tenant ID of a configuration request source in the management table 112a.

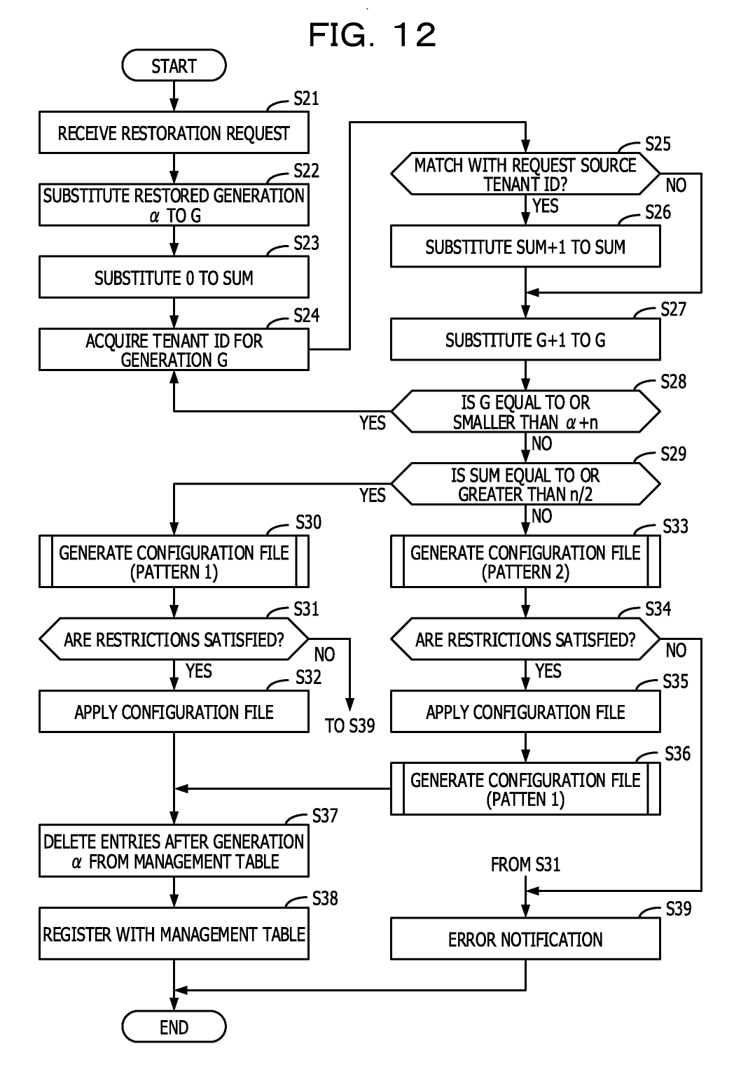

FIG. 12 is a flowchart illustrating an example of a restoration process. Hereinafter, the process illustrated in FIG. 12 will be described.

(S21) The request reception unit 120 receives a request to restore the L2 switch 200 from a terminal device. The restoration request contains a tenant ID of a request source, and a restored generation a (a generation of a configuration to be restored). The request reception unit 120 instructs the restoration unit 140 to execute the process of restoring the L2 switch 200.

(S22) The restoration unit 140 substitutes the restored generation a (a is an integer equal to or greater than 0) to a variable G (G is an integer equal to or greater than 0).

(S23) The restoration unit 140 substitutes 0 to a variable SUM (SUM is an integer equal to or greater than 0).

(S24) The restoration unit 140 acquires the tenant ID for the generation G with reference to the management table 112a.

(S25) The restoration unit 140 determines whether the tenant ID acquired in S24 matches the tenant ID of the restoration request source. When they match, the process proceeds to S26. When they do not match, the process proceeds to S27.

(S26) The restoration unit 140 substitutes SUM+1 to the variable SUM. Here, calculation of SUM+1 is a calculation of adding 1 to the value substituted to the variable SUM.

(S27) The restoration unit 140 substitutes G+1 to the variable G. Here, calculation of G+1 is a calculation of adding 1 to the value substituted to the variable G. If other information such as a time stamp is used as the generation, calculation of G+1 may be considered as a calculation of acquiring a generation that is later by one generation.

(S28) The restoration unit 140 determines whether the value substituted to the variable G is equal to or less than α+n (n is an integer equal to or greater than 1). If the value substituted to the variable G is equal to or less than a+n, the process proceeds to S24. If the value substituted to the variable G is greater than α+n, the process proceeds to S29. Here, n is the number of generations (the number of the configuration files) after the restored generation a to a latest generation registered in the management table 112a. For example, if α=K and the latest generation is generation K+5, n=5. That is, the generation α+n indicates the latest generation registered in the management table 112a. In S28, a determination is made as to whether the variable G indicates a generation of the latest generation α+n or before.

(S29) The restoration unit 140 determines whether the value substituted to the variable SUM is equal to or greater than n/2. If the value substituted to the variable SUM is equal to or greater than n/2, the process proceeds to S30. If the value substituted to the variable SUM is smaller than n/2, the process proceeds to S33. The process of S29 is a process of comparing the number (SUM) of times the update is performed by the tenant which is the restoration request source within a period after the restored generation a to the latest generation α+n with the number (n−SUM) of times the update is performed by other tenants or the administrator within the period. When the value substituted to the variable SUM is equal to or greater than n/2, SUM is equal to or greater than n−SUM. If the value substituted to the variable SUM is smaller than n/2, SUM is smaller than n−SUM.

(S30) The restoration unit 140 performs a process (pattern_1) of generating a configuration file for configuration restoration on the basis of the configuration file group 111a and the management table 112a. In pattern_1, the restoration unit 140 generates the configuration file for configuration restoration by reflecting, in the configuration file of the restored generation, the configuration contents set by tenants other than the tenant that is the restoration request source or the administrator in the generations later than the restored generation. If there are a plurality of generations later than the restored generation, intermediate configuration files (intermediate backup files) in which the change by the tenant which is the restoration request source has been removed are sequentially generated. Details will be described later.

(S31) The restoration unit 140 determines whether the configuration file for configuration restoration generated in S30 satisfies the restrictions with reference to the restriction table 113a. When the configuration file for configuration restoration satisfies the restrictions, the process proceeds to S32. When the configuration file for configuration restoration does not satisfy the restrictions, the process proceeds to S39.

(S32) The restoration unit 140 inputs the configuration file for configuration restoration generated in S30 to the L2 switch 200 to change the configuration of the L2 switch 200 (application of the configuration file). Then, the process proceeds to S37.

(S33) The restoration unit 140 performs a process (pattern_2) of generating a configuration file for configuration restoration on the basis of the configuration file group 111a and the management table 112a. In pattern_2, the configuration set by the tenant that is the restoration request source is put back from the latest generation to the restored generation on the basis of the configuration file of the latest generation to generate the configuration file for configuration restoration. Details will be described later.

(S34) The restoration unit 140 determines whether the configuration file for configuration restoration generated in S33 satisfies the restrictions with reference to the restriction table 113a. When the configuration file for configuration restoration satisfies the restrictions, the process proceeds to S35. When the configuration file for configuration restoration does not satisfy the restrictions, the process proceeds to S39.

(S35) The restoration unit 140 inputs the configuration file for configuration restoration generated in S33 to the L2 switch 200 to change the configuration of the L2 switch 200 (application of the configuration file).

(S36) The restoration unit 140 performs the process (pattern_1) of generating a configuration file for configuration restoration on the basis of the configuration file group 111a and the management table 112a.

(S37) The restoration unit 140 deletes entries after the generation a from the management table 112a.

(S38) The restoration unit 140 registers information of the configuration file generated in S30 or S36 in the management table 112a. Then, the process ends.

(S39) Since the restrictions of the configuration file for the L2 switch 200 are not satisfied, the restoration unit 140 transmits (error notification), to the terminal device that is the restoration request source, the fact that the restoration to the generation a is not performed. Then, the process ends.

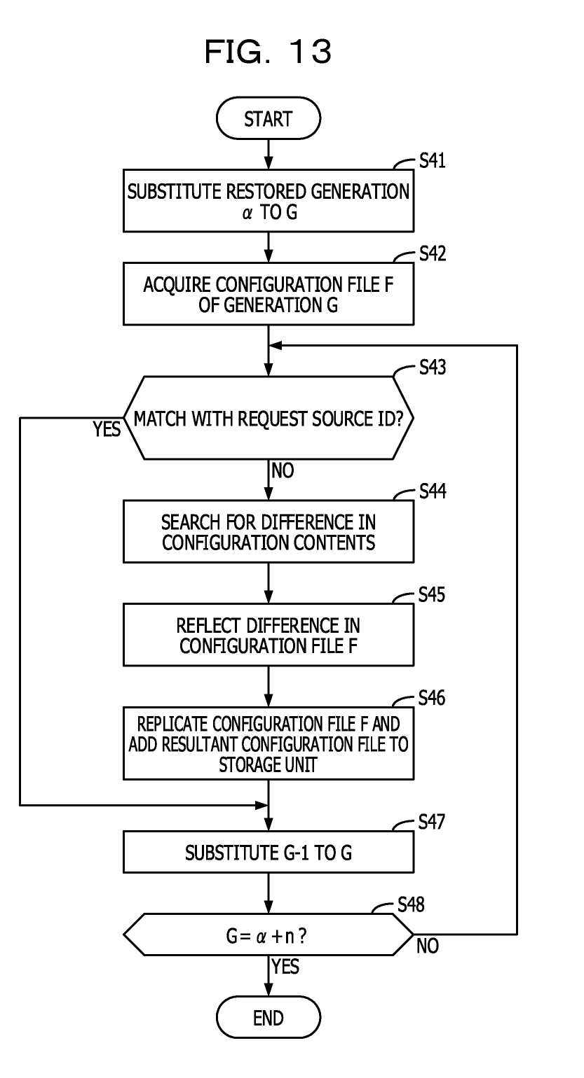

FIG. 13 is a flowchart illustrating an example of the process (pattern_1) of generating a configuration file. Hereinafter, the process illustrated in FIG. 13 will be described.

(S41) The restoration unit 140 substitutes the restored generation a to the variable G.

(S42) The restoration unit 140 acquires a configuration file F of the generation G from the storage unit 110.

(S43) The restoration unit 140 determines whether the tenant ID of the tenant which has changed the configuration file in the generation G+1 matches the tenant ID of the restoration request source with reference to the management table 112a. When they do not match, the process proceeds to S44. When they match, the process proceeds to S47.

(S44) The restoration unit 140 searches for the difference (changes applied in the generation G+1 to the configuration contents of the generation G) between the configuration file of the generation G and the configuration file of the generation G+1. In S44, the restoration unit 140 extracts the difference made by a tenant other than the restoration request source or the administrator.

(S45) The restoration unit 140 reflects the searched difference in the configuration file F. For example, if the difference is addition of a configuration, the restoration unit 140 adds the configuration to the configuration file F. If the difference is an update of an existing configuration, the restoration unit 140 similarly updates the configuration of the configuration file F. If the difference is deletion of a configuration, the restoration unit 140 deletes the configuration from the configuration file F.

(S46) The restoration unit 140 replicates the configuration file F, assigns a predetermined file name to the replicated configuration file, and stores the replicated configuration file in the storage unit 110. Accordingly, a new configuration file is added to the configuration file group 111a.

(S47) The restoration unit 140 substitutes G+1 to the variable G.

(S48) The restoration unit 140 determines whether G =α+n, that is, the value substituted to the variable G is equal to α+n. If G=α+n, the process ends. If G ≠α+n, the process proceeds to S43.

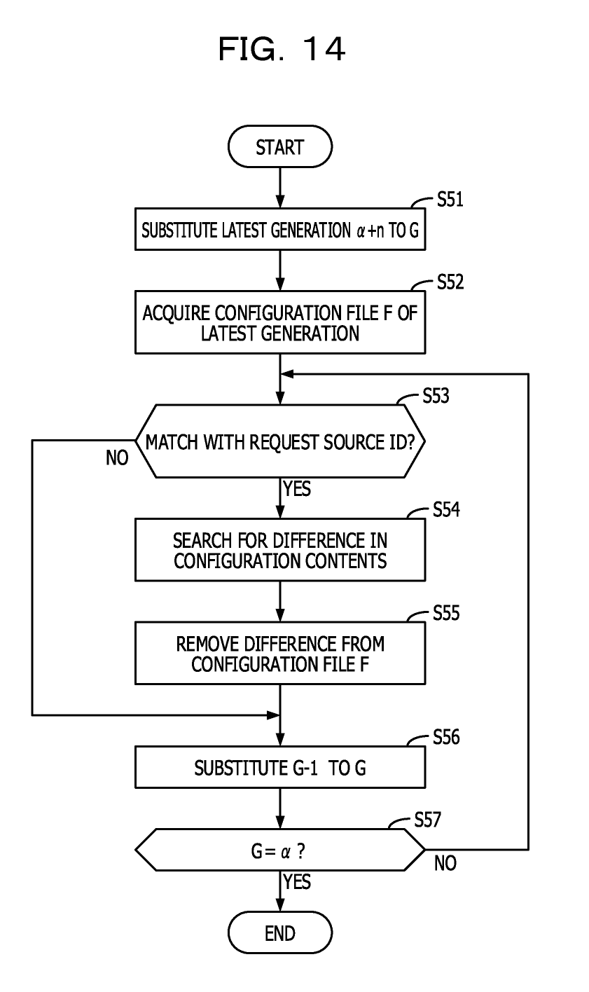

FIG. 14 is a flowchart illustrating an example of the process (pattern_2) of generating a configuration file. Hereinafter, the process illustrated in FIG. 14 will be described.

(S51) The restoration unit 140 substitutes the latest generation α+n to the variable G.

(S52) The restoration unit 140 acquires the configuration file F of the latest generation α+n from the storage unit 110.

(S53) The restoration unit 140 determines whether the tenant ID of the tenant which has performed change of the configuration file in the generation G matches the tenant ID of the restoration request source with reference to the management table 112a. When they match, the process proceeds to S54. When they do not match, the process proceeds to S56.

(S54) The restoration unit 140 searches for a difference (a change applied in the generation G to the configuration contents of the generation G−1) between the configuration file of the generation G and the configuration file of the generation G−1. In S54, the restoration unit 140 extracts the difference made by the tenant which is the restoration request source.

(S55) The restoration unit 140 removes the searched difference from the configuration file F. For example, if the difference is addition of a configuration, the restoration unit 140 deletes the added configuration from the configuration file F. If the difference is update of an existing configuration, the restoration unit 140 returns the configuration after the update in the configuration file F to the configuration in the generation G−1. If the difference is deletion of a configuration, the restoration unit 140 adds the deleted configuration (configuration presented in generation G−1) to the configuration file F.

(S56) The restoration unit 140 substitutes G−1 to the variable G. Here, a calculation of G−1 is a calculation of subtracting 1 from the value substituted to the variable G. If other information such as a time stamp is used as a generation, the calculation of G−1 may be considered as a calculation of acquiring a generation earlier by one generation.

(S57) The restoration unit 140 determines whether G=α, that is, if the value substituted to the variable G is equal to α. If G=α, the process ends. If G ≠α, the process proceeds to S53.

Thus, the management server 100 generates the configuration file for configuration restoration and restores the configuration of the L2 switch 200 to the designated generation. Particularly, the management server 100 selects the method with a smaller calculation amount from among the methods of pattern_1 or pattern_2 as a method of generating a configuration file for configuration restoration. Specifically, when SUM <n/2 in S29 of FIG. 12, a calculation cost for generating the configuration file for configuration restoration in the selection of pattern_2 is likely to be lower than that in the selection of pattern_1. The reasons are as follows.

The value of n indicates the number of times the configuration change is performed (the number of times the update is performed) by all tenants and the administrator within a period after the restored generation to the latest generation. In S29 of FIG. 12, SUM indicates the number of times the configuration change is performed (the number of times the update is performed) by the tenant that is the restoration request source among the n times. Thus, n−SUM is the number of times the update is performed by other tenants and the administrator. Thus, when SUM is smaller than n/2 (that is, when the number of times the update is performed by the tenant which is the restoration request source is smaller than the number of times the update is performed by the other tenants and the administrator), it is effective to search for a difference made by the tenant which is the restoration request source. For example, the number of executions of S54 and S55 of FIG. 14 is smaller than the number of executions of S44 and S45 of FIG. 13. In this case, using pattern_2, it is possible to speed up generation of the configuration file for configuration restoration in comparison with pattern_1. Therefore, it is possible to speed up the restoration of the configuration of the network device 2.

When pattern_2 is selected, the intermediate backup file, in which the changes by the tenant which is the restoration request source have been removed, is not generated contrary to pattern_1. Therefore, when pattern_2 is selected, the management server 100 generates the intermediate backup files by separately executing the configuration file generation process of pattern_1 (S36 of FIG. 12). The management server 100 may execute S36 in parallel to the process of S33 to S35 of FIG. 12.

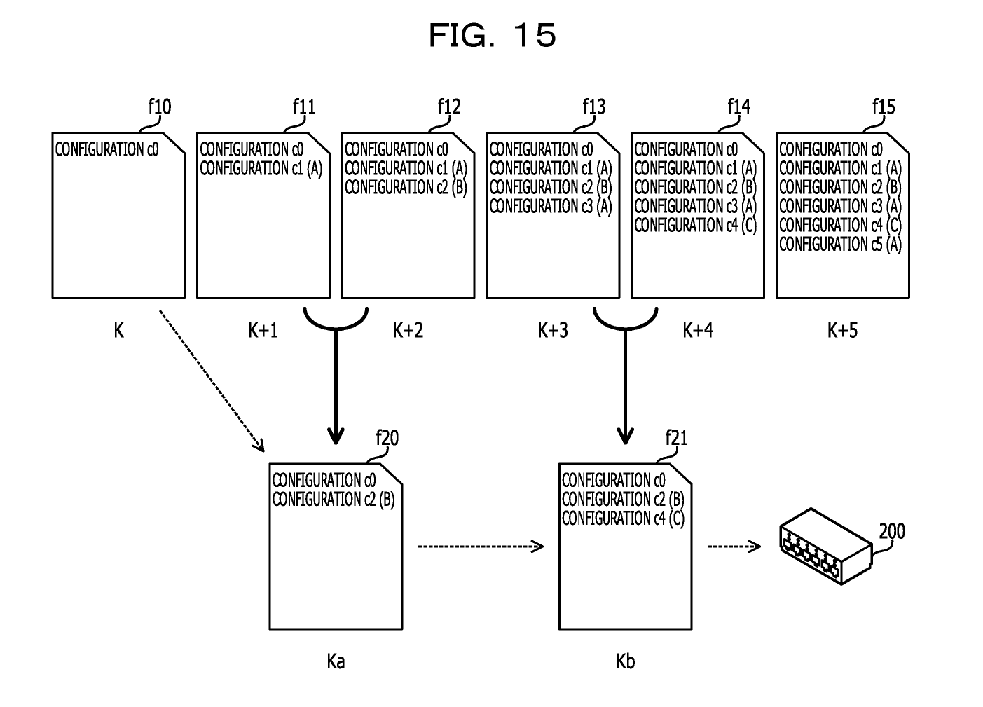

FIG. 15 is a diagram illustrating a specific example of the process (pattern_1) of generating a configuration file. FIG. 15 illustrates a case in which the management server 100 has received a request for restoration to a generation K from tenant A when the most recent generations are generations K, K+1, K+2, K+3, K+4, and K+5. In FIG. 15, a sign indicating the tenant or the administrator who has performed configuration change is attached as follows. “(A)” indicates that tenant A has performed the configuration change. “(B)” indicates that tenant B has performed the configuration change. “(C)” indicates that the administrator has performed the configuration change.

In the example of FIG. 15, n=5. Further, in S29 of FIG. 12, SUM=3. SUM=3 is equal to or more than n/2=5/2. Thus, the management server 100 determines that a configuration file for restoration is to be generated using the method of pattern_1. The management server 100 acquires the configuration file f10 of the generation K from the storage unit 110. Then, the management server 100 performs the following process.

The management server 100 confirms that the configuration change by tenant A has been performed in the generation K+1 with reference to the management table 112a. Since tenant A is the restoration request source, the difference between generation K and generation K+1 is not extracted.

The management server 100 confirms that the configuration change by tenant B has been performed in the generation K+2 with reference to the management table 112a. Since tenant B is not the restoration request source, a difference between the configuration file f11 of the generation K+1 and the configuration file f12 of the generation K+2 is extracted. In this case, the difference is the configuration c2. Thus, the management server 100 generates the configuration file f20 by reflecting the configuration c2 in the configuration file f10.

The configuration c2 is addition of the configuration of the VLAN interface. Therefore, the management server 100 generates the configuration file f20 by adding the configuration to the configuration file f10.

The management server 100 confirms that the configuration change by tenant A has been performed in the generation K+3 with reference to the management table 112a. Since tenant A is the restoration request source, a difference between generation K+2 and generation K+3 is not extracted.

The management server 100 confirms that the configuration change by the administrator has been performed in the generation K+4 with reference to the management table 112a. Since the administrator is not the restoration request source, a difference between the configuration file f13 of the generation K+3 and the configuration file f14 of the generation K+4 is extracted. In this case, the difference is the configuration c4. Thus, the management server 100 generates a configuration file f21 by reflecting the configuration c4 in the configuration file f20.

The configuration c4 is update of a password. Therefore, the management server 100 generates the configuration file f21 by similarly updating the password in the configuration file f20.

The management server 100 confirms that the configuration change by tenant A has been performed in the generation K+5 with reference to the management table 112a. Since tenant A is the restoration request source, a difference between generation K+4 and generation K+5 is not extracted.

In this case, the latest configuration by a tenant other than tenant A or the administrator has been reflected in the configuration file f21. Thus, the configuration file f21 becomes the configuration file for configuration restoration. The configuration file f21 is assumed to satisfy the restrictions of the restriction table 113a. The management server 100 performs configuration change of the L2 switch 200 by inputting the configuration file f21 to the L2 switch 200. Accordingly, the configuration of the L2 switch 200 is restored up to the generation K for tenant A. On the other hand, the configuration of the L2 switch 200 which has been performed in the generation K+2 is maintained for tenant B. The configuration of the L2 switch 200 which has been performed in the generation K+4 is maintained for the administrator.

The management server 100 assigns generations to the configuration files f20 and f21, as follows. As the generation of the configuration file f20, a generation Ka which is later than the generation K of the configuration file f10 is assigned. Generation Ka may be the generation K+2. As the generation of the configuration file f21, a generation Kb which is later than the generation Ka is assigned. The generation Kb may be the generation K+4. The generation Kb is a latest generation immediately after the restoration.

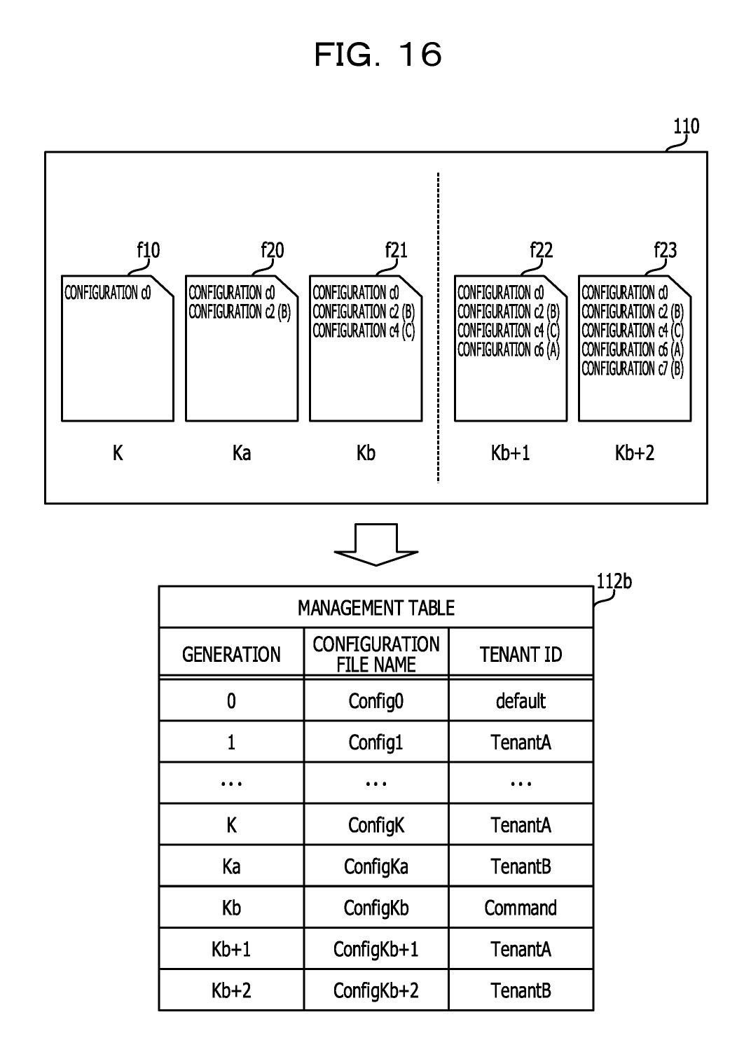

FIG. 16 is a diagram illustrating a specific example of the process (pattern_1) of generating a configuration file. The management server 100 stores the configuration files f20 and f21 in the storage unit 110. The management server 100 deletes entries for configuration files f11, f12, f13, f14, and f15 from the management table 112a.

The management server 100 registers information of the configuration files f20 and f21 with the management table 112a. Specifically, the management server 100 registers a correspondence relationship between a generation “Ka”, a configuration file name “ConfigKa”, and a tenant ID “TenantB” in the management table 112a. This is because the configuration file f20 is a configuration file obtained by reflecting the configuration change (configuration c2) made by tenant B in the configuration file f10.

Further, the management server 100 registers a correspondence relationship between a generation “Kb”, a configuration file name “ConfigKb”, and a tenant ID “Command” in the management table 112a. This is because the configuration file f21 is a configuration file obtained by reflecting a configuration change (configuration c4) made by the administrator in the configuration file f20. The configuration file f21 may be a configuration file obtained by reflecting the configurations c2 and c4 in the configuration file f10 sequentially from the configuration corresponding to an earlier generation.

Thus, the management server 100 updates the configuration files f12 and f14 corresponding to the tenant IDs other than that of the restoration request source among the configuration files of the generations later than the restored generation K into the newly generated configuration files f20 and f21. Further, the entries for the configuration files f11, f13, and f15 corresponding to the tenant ID of the restoration request source among the configuration files of the generations later than the generation K are deleted from the management table 112a so as to invalidate the existing configuration files corresponding to the tenant ID of the restoration request source.

Then, the management server 100 may use the configuration files f20 and f21 stored in the storage unit 110 as a new series of backup files in place of the configuration files f11, f12, f13, f14, and f15. The management server 100 may delete the configuration files f11, f12, f13, f14, and f15 from the storage unit 110.

Then, the similar operation to the operation before the restoration is performed. For example, a configuration file f22 of a generation Kb+1 is acquired in accordance with a configuration change (configuration c6) made by tenant A. Further, a configuration file f23 of a generation Kb+2 is acquired in accordance with a configuration change (configuration c7) made by tenant B. FIG. 16 illustrates a management table 112b in which information up to the configuration file f23 is registered.

By generating new backup files, the management server 100 may appropriately perform the restoration process when another restoration request is performed by a tenant other than the tenant which is the restoration request source. For example, a restoration request in which the generation Ka is designated is assumed to be performed by tenant B. If the configuration file for configuration restoration is generated using pattern_1, the management server 100 reflects, in the configuration file f20 of the generation Ka, configuration changes made after the generation Ka by a tenant (tenant A) other than tenant B and the administrator. In this case, the configuration files f11, f13, and f15 are invalidated at a point in time of previous restoration by tenant A. Thus, the configurations c1, c3, and c5 of tenant A in the configuration files f11, f13, and f15 are not reflected.

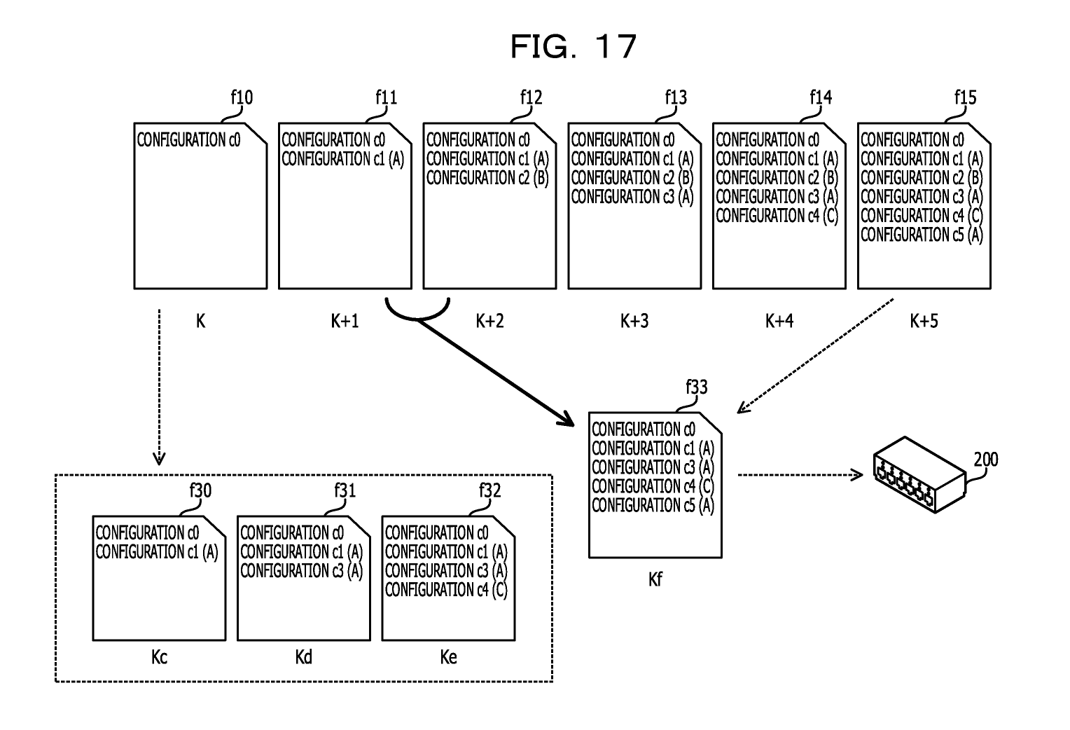

FIG. 17 is a diagram illustrating a specific example of the process (pattern_2) of generating a configuration file. FIG. 17 illustrates a case in which the management server 100 has received a request for restoration to a generation K from tenant B when the most recent generations are generations K, K+1, K+2, K+3, K+4, and K+5. In FIG. 17, a sign indicating the tenant or the administrator who has performed configuration change is attached as in FIG. 15 (for example, “(A)”).

In the example of FIG. 17, n=5. Further, SUM=1 in S29 of FIG. 12. SUM=1 is smaller than n/2=5/2. Thus, the management server 100 determines to generate a configuration file for restoration using the method of pattern_2. The management server 100 acquires the configuration file f15 of a generation K+5 from the storage unit 110. Then, the management server 100 performs the following process.

The management server 100 confirms that the configuration change has been performed by tenant A in the generation K+5 with reference to the management table 112a. Since tenant A is not the restoration request source, a difference between generation K+4 and generation K+5 is not extracted.

The management server 100 confirms that the configuration change has been performed by the administrator in the generation K+4 with reference to the management table 112a. Since the administrator is not the restoration request source, a difference between generations K+3 and generation K+4 is not extracted.

The management server 100 confirms that the configuration change has been performed by tenant A in the generation K+3 with reference to the management table 112a. Since tenant A is not the restoration request source, a difference between generation K+2 and generation K+3 is not extracted.

The management server 100 confirms that the configuration change has been performed by tenant B in the generation K+2 with reference to the management table 112a. Since tenant B is the restoration request source, a difference between the configuration file f11 of the generation K+1 and the configuration file f12 of the generation K+2 is extracted. In this case, the difference is the configuration c2. Thus, the management server 100 generates a configuration file f33 by removing the configuration c2 from the configuration file f15.

The configuration c2 is addition of the configuration of the VLAN interface. Therefore, the management server 100 generates the configuration file f33 by deleting the configuration from the configuration file f15.

The management server 100 confirms that the configuration change has been performed by tenant A in the generation K+1 with reference to the management table 112a. Since tenant A is not the restoration request source, a difference between generation K and generation K+1 is not extracted.

In this case, the latest configuration by a tenant other than tenant B or the administrator has been reflected in the configuration file f33. Thus, the configuration file f33 becomes the configuration file for configuration restoration. The configuration file f33 is assumed to satisfy the restrictions of the restriction table 113a. The management server 100 performs configuration change of the L2 switch 200 by inputting the configuration file f33 to the L2 switch 200. Accordingly, the configuration of the L2 switch 200 is restored up to the generation K for tenant B. On the other hand, the configurations of the L2 switch 200 performed in the generations K+1, K+3, and K+5 are maintained for tenant A. The configuration of the L2 switch 200 performed in the generation K+4 is maintained for the administrator.

Further, the management server 100 separately generates configuration files f30, f31, and f32 in which the configurations by tenant A and the administrator have been sequentially reflected between the configuration file f10 and the configuration file f33. A method of generating the configuration files f30, f31, and f32 is similar to the method of generating configuration files in pattern_1 described above. However, in this case, the configuration file f33 has been generated in the generation process of pattern_2. Therefore, the configuration file f33 may or may not be generated again.

The management server 100 assigns generations to the configuration files f30, f31, f32, and f33 as follows. A generation Kc which is later than the generation K of the configuration file f10 is assigned as the generation of the configuration file f30. The generation Kc may be generation K+1. A generation Kd which is later than the generation Kc is assigned as the generation of the configuration file f31. The generation Kd may be generation K+3. A generation Ke which is later than the generation Kd is assigned as the generation of the configuration file f32. The generation Ke may be generation K+4. A generation Kf which is later than the generation Ke is assigned as the generation of the configuration file f33. The generation Kf may be generation K+5. The generation Kf is the latest generation immediately after the restoration.

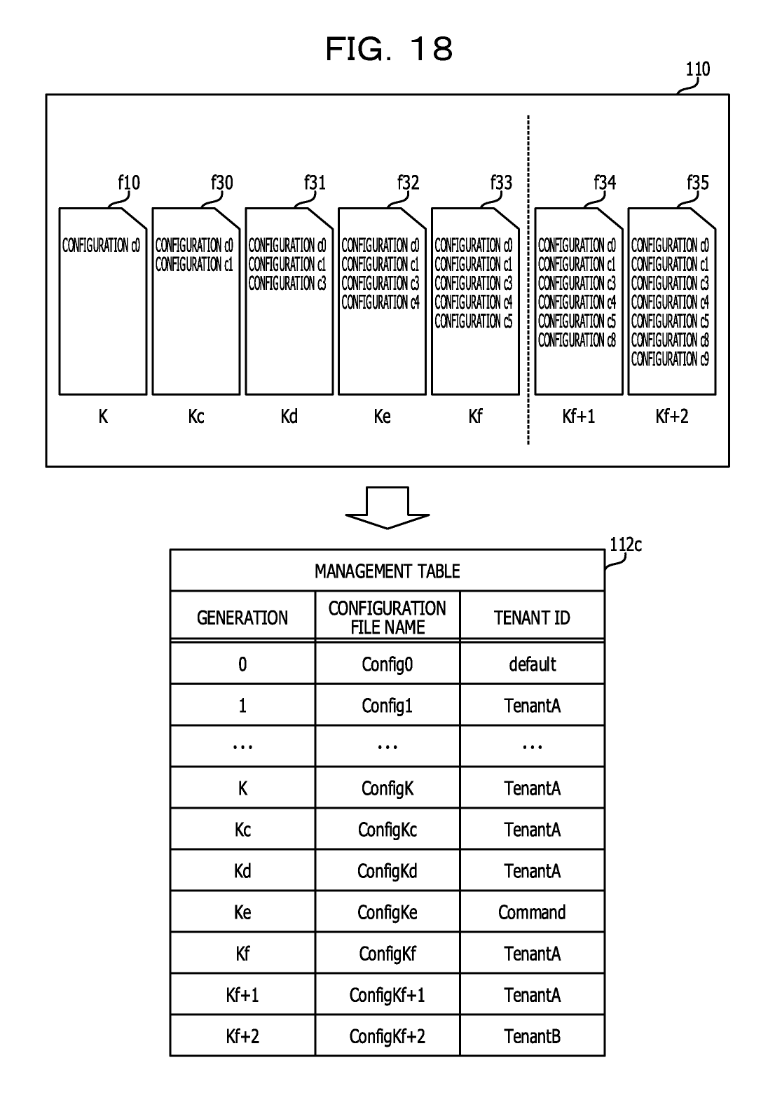

FIG. 18 is a diagram illustrating a specific example of the process (pattern_2) of generating a configuration file. The management server 100 stores configuration files f30, f31, f32, and f33 in the storage unit 110. The management server 100 deletes entries for the configuration files f11, f12, f13, f14, and f15 from the management table 112a.

Also, the management server 100 registers information of the configuration files f30, f31, f32, and f33 in the management table 112a. Specifically, the management server 100 registers a correspondence relationship among a generation “Kc”, a configuration file name “ConfigKc”, and a tenant ID “TenantA” in the management table 112a. The management server 100 registers a correspondence relationship among a generation “Kd”, a configuration file name “ConfigKd”, and a tenant ID “TenantA” in the management table 112a. The management server 100 registers a correspondence relationship among generation “Ke”, a configuration file name “ConfigKe”, and a tenant ID “Command” in the management table 112a. The management server 100 registers a correspondence relationship among generation “Kf”, a configuration file name “ConfigKf”, and a tenant ID “TenantA” in the management table 112a.

Thus, the management server 100 updates configuration files f11, f13, f14, and f15 corresponding to tenant IDs other than the restoration request source among the configuration files of the generations later than the restored generation K into newly generated configuration files f30, f31, f32, and f33. Further, the entry for the configuration file f12 corresponding to the tenant ID of the restoration request source among the configuration files of the generations later than the generation K is deleted from the management table 112a to invalidate the existing configuration file corresponding to the tenant ID of the restoration request source.

Then, the management server 100 may use the configuration files f30, f31, f32, and f33 stored in the storage unit 110 as a new series of backup files in place of the configuration files f11, f12, f13, f14, and f15. The management server 100 may delete the configuration files f11, f12, f13, f14, and f15 from the storage unit 110.

Then, the similar operation to the operation before the restoration is performed. For example, the configuration file f34 of a generation Kf+1 is acquired in accordance with a configuration change (configuration c8) made by tenant A. Further, a configuration file f35 of a generation Kf+2 is acquired in accordance with a configuration change (configuration c9) made by tenant B. FIG. 18 illustrates a management table 112c in which information up to the configuration file f35 is registered.

Here, a reason for generation of the new backup files is similar to the reason described in FIG. 16. That is, by generating new backup files, the management server 100 may appropriately perform the restoration process when another restoration request is performed by a tenant other than the tenant which is the restoration request source. For example, a restoration request in which the generation Kc is designated is assumed to be performed by tenant A. If the configuration file for configuration restoration is generated using pattern_1, the management server 100 reflects, in the configuration file f30 of generation Kc, configuration changes made after the generation Kc by a tenant (tenant B) other than tenant A and the administrator. In this case, the configuration file f12 is invalidated at a point in time of the previous restoration by tenant B. Thus, the configuration c2 of tenant B in the configuration file f12 is not reflected.

Further, the management server 100 selects, from pattern_1 and pattern_2, a method whose calculation amount used for generating the configuration file is estimated to be smaller, as a method of generating a configuration file for configuration restoration (S29 of FIG. 12). Accordingly, it is possible to speed up the generation of the configuration file for configuration restoration. As a result, it is possible to speed up a configuration change of the L2 switch 200.

For example, the management server 100 restricts each tenant from changing the configuration of the L2 switch 200 while the configuration file for configuration restoration is being generated. This is because the restoration of the configuration is not appropriately performed when the configuration file of the latest generation is changed. However, it is preferable that the time of restricting each tenant from changing the configuration of the L2 switch 200 be short from the viewpoint of continuous use of service. As described above, the management server 100 may shorten the time of restricting changing of the configuration of the L2 switch by selecting the method that may speed up generation of the configuration file.

Whether the pattern_1 or pattern_2 is to be selected may be determined based on more detailed information. For example, the configuration change performed in a certain generation may be represented by a plurality of lines in the configuration file (for example, the configurations c1, c2, and c5 illustrated in FIG. 6). A calculation cost may increase in searching for a difference from a previous generation or in reflecting the difference in the configuration file, as the configuration change in a certain generation is represented by more lines. Therefore, the number of lines in the configuration file may be considered for the value set in SUM.

Specifically, the number m (m is an integer equal to or more than 1) of all lines subjected to configuration change (addition, update, and deletion) in generations after the restored generation to the latest generation is used in place of n in S29 of FIG. 12. Further, in S26 of FIG. 12, the number of lines subjected to configuration change in the generation G by the tenant which is the restoration request source is added to the variable SUM.

In the determination of S29, the restoration unit 140 determines whether “SUM is equal to or more than m/2” (whether the number of times the update is performed by the tenant that made a restoration request is equal to or greater than the number of times the update is performed by other tenants and the administrator). If SUM is equal to or more than m/2 (if the number of times the update is performed by the tenant which is the restoration request source is equal to or greater than the number of times the update is performed by other tenants and the administrator), the process proceeds to S30 (pattern_1 is selected). If SUM is smaller than m/2 (if the number of times the update is performed by the tenant which is the restoration request source is smaller than the number of times the update is performed by other tenants and the administrator), the process proceeds to S33 (pattern_2 is selected). Thus, using the number of updates in consideration of the number of lines subjected to the configuration change, a determination may be made as to which of pattern_1 and pattern_2 is to be selected. Accordingly, the restoration unit 140 may more exactly select a method with a low calculation cost in the generation of the configuration file for configuration restoration.

In the description described above, while the calculation of the variable SUM is performed after the restoration request is received (S23 to S28 of FIG. 12), SUM may be totaled each time the configuration request is received. In this case, for example, the configuration processing unit 130 stores information in which the generation and a value of SUM for each tenant (SUM is prepared for each tenant) are associated, in a predetermined storage area of the RAM 102 or the HDD 103. The configuration processing unit 130 adds 1 (the number of changed lines when the number of lines is further considered) to SUM corresponding to the tenant each time a configuration request is received from a tenant. Also, when the restoration unit 140 receives a restoration request from a tenant, a SUM value of the tenant is read from the information stored in the RAM 102 or the HDD 103, and S29 of FIG. 12 is executed. In this case, the restoration unit 140 may omit S22 to S28. Thus, it is possible to further speed up the generation of the configuration file for configuration restoration.

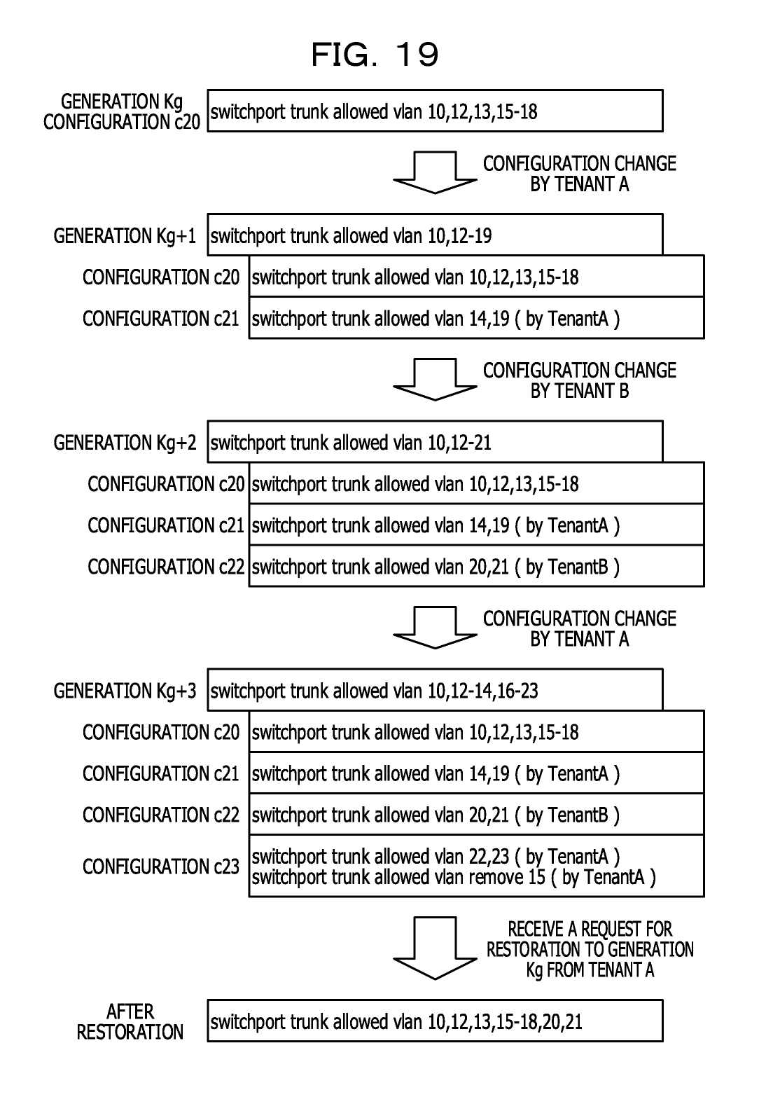

FIG. 19 is a diagram illustrating another configuration example of the configuration file. A configuration c20 is a configuration in a generation Kg. The configuration c20 corresponds to a description of “switchport trunk allowed vlan 10, 12, 13, 15-18” within the configuration file.

The configuration c20 designates VLAN IDs “10, 12, 13, 15, 16, 17, 18” as being allowed for communication in a port (hereinafter referred to as a trunk port) connecting the L2 switch 200 and another switch (not illustrated in FIG. 2). Notation of “15-18” indicates “15, 16, 17, 18”. Thus, when three or more VLAN IDs are designated, ID designation is abbreviated by a sign of hyphen “-” depending on a network device. For example, a configuration of the trunk port is changed for generations Kg to Kg+3, as follows.

In a generation Kg+1, VLAN IDs “14, 19” are added for the trunk port by tenant A. Then, a designation section of the VLAN IDs for the trunk port is rewritten into “vlan 10, 12-19”. In this case, a difference from the generation Kg (configuration c20) is “switchport trunk allowed vlan 14, 19” (configuration c21).

In a generation Kg+2, VLAN IDs “20, 21” are added for the trunk port by tenant B. Then, the designation section of the VLAN IDs for the trunk port is rewritten into “vlan 10, 12-21”. In this case, a difference from the generation Kg+1 (a configuration of a combination of the configurations c20 and c21) is “switchport trunk allowed vlan 20, 21” (configuration c22).

In a generation Kg+3, VLAN IDs “22, 23” are added and VLAN ID “15” is deleted for the trunk port by tenant A. Then, the designation section of the VLAN IDs for the trunk port is rewritten into “vlan 10,12-14,16-23”. In this case, a difference from the generation Kg+2 (a configuration of a combination of the configurations c20, c21, and c22) is both “switchport trunk allowed vlan 22, 23” and “switchport trunk allowed vlan remove 15” (configuration c23).

Then, the management server 100 receives a request for restoration to the generation Kg from tenant A. In the example of FIG. 19, n=3. In S29 of FIG. 12, SUM=2. SUM=2 is equal to or greater than n/2=3/2. Thus, the management server 100 generates a configuration file for restoration using the method of pattern_1. Specifically, a configuration c22 by tenant B other than tenant A is reflected in the configuration c20. The management server 100 generates a configuration file, including “switchport trunk allowed vlan 10, 12, 13, 15-18, 20, 21” as a configuration after restoration of the trunk port. The configuration of the L2 switch 200 is restored up to the generation Kg for tenant A by using this configuration file. On the other hand, the configuration of the L2 switch 200 performed in the generation Kg+2 is maintained for tenant B. Further, the management server 100 may extract a difference in a configuration file between the generations regardless of a method of describing the configuration file in the network device, as described above.

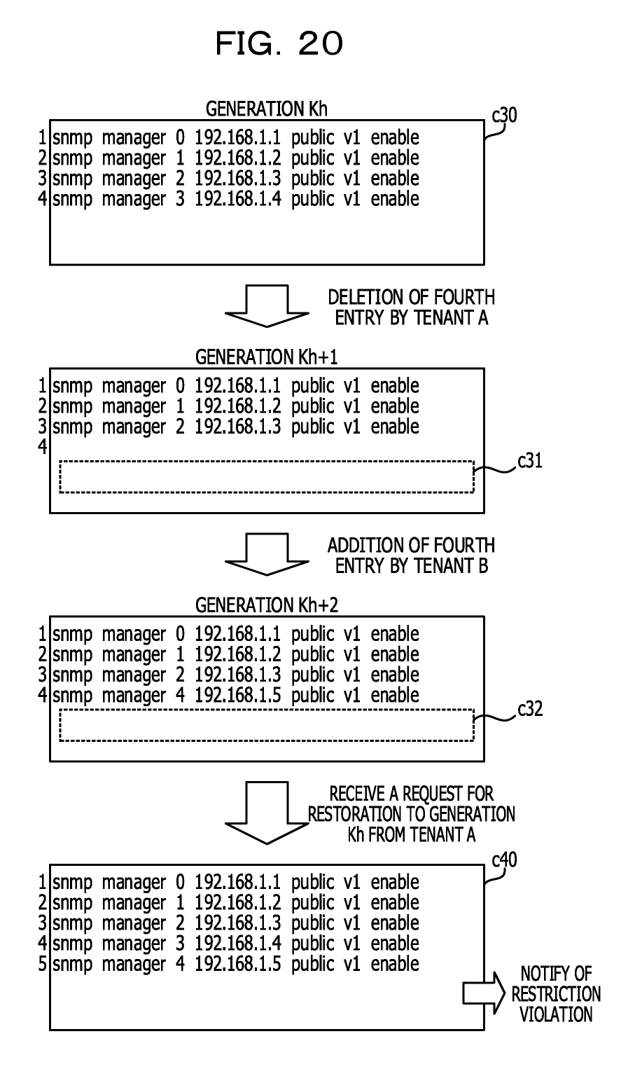

FIG. 20 is a diagram illustrating yet another configuration example of the configuration file. A configuration c30 is a configuration in a generation Kh. The configuration c30 corresponds to a description of four lines (four configuration commands), including, for example, “0 SNMP manager 192.168.1.1 public v1 enable” within the configuration file. Here, a numerical value on the left side of each configuration in FIG. 20 indicates a line number.

The configuration c30 is a configuration for designating an SNMP manager which is a transmission destination of a SNMP trap or the like for an SNMP agent operating in the L2 switch 200. A configuration of one line corresponds to designation of one SNMP manager. In the configuration c30, four SNMP managers are designated. The upper limit of the number of SNMP managers designated in the L2 switch 200 is 4, as illustrated in the restriction table 113a. For example, a configuration of an SNMP agent from the generation Kh to a generation Kh+2 is changed as follows.

In the generation Kh+1, an entry of a fourth line of the configuration c30 is deleted by tenant A. A configuration c31 which is a difference from the generation Kh corresponds to the deletion of the entry.

In a generation Kh+2, an entry of the fourth line is added to the configuration c31 by tenant B. A configuration c32 which is a difference from the generation Kh+1 corresponds to the addition of the entry.

Then, the management server 100 receives a request for restoration to the generation Kh by tenant A. In the example of FIG. 20, n=2. In S29 of the procedure of FIG. 12, SUM=1. SUM=1 is equal to or more than n/2=2/2=1. Thus, the management server 100 generates a configuration file for restoration using the method of pattern_1. Specifically, the configuration c32 by tenant B other than tenant A is reflected in the configuration c30. The management server 100 generates a configuration file containing a configuration c40 of five lines, including, for example, “0 SNMP manager 192.168.1.1 public v1 enable” as a configuration after the restoration. Then, in the configuration c40, five SNMP managers are designated.

The management server 100 determines whether the configuration file after the restoration satisfies the restrictions on the basis of the restriction table 113a. This is because the L2 switch 200 may not normally operate when the configuration file after the restoration does not satisfy the restrictions. In the above case, the restrictions are violated since the five SNMP managers are designated even though the upper limit of the SNMP managers in the configuration c40 is 4.

Therefore, the management server 100 does not perform the configuration of the L2 switch 200 using the generated configuration file, and notifies tenant A which is the restoration request source that the restoration is not performed due to the restriction violation. The management server 100 may perform similar notification for the administrator. For example, the management server 100 may perform the notification by generating and transmitting an e-mail destined to an e-mail address of the tenant A or the administrator. Alternatively, the management server 100 may perform the notification by generating and transmitting a predetermined message destined to the identification information of the terminal device 21 or 400. Thus, an unauthorized configuration of the L2 switch 200 may be avoided. Further, it is possible to have tenant A or the administrator appropriately recognize that the requested restoration is not performed.

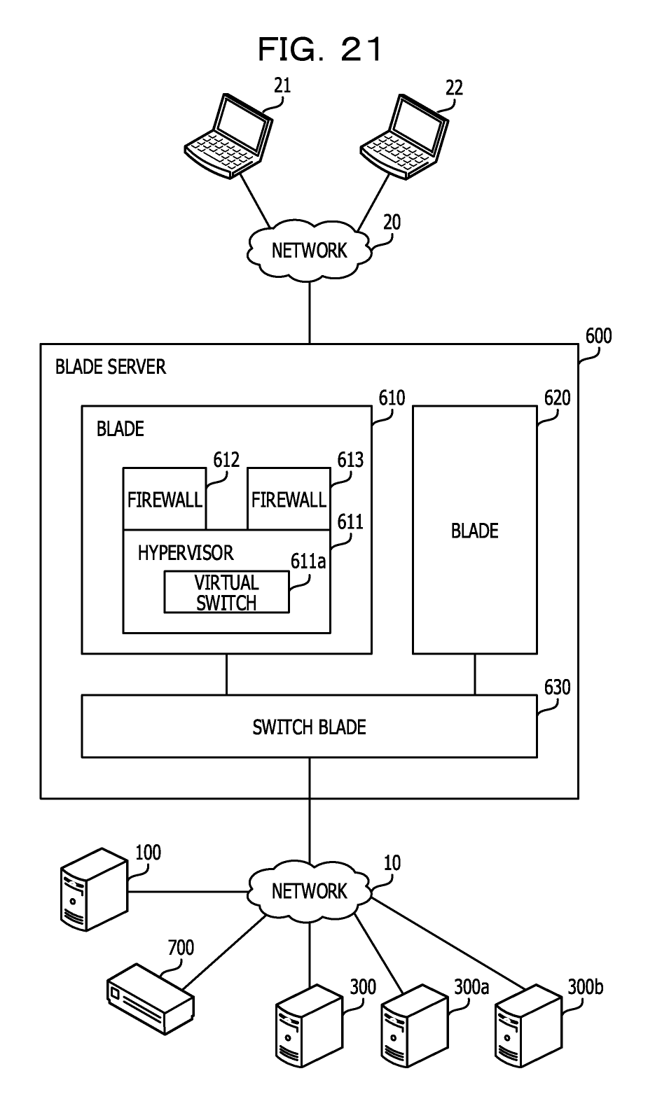

FIG. 21 is a diagram illustrating an example of a network device. While the L2 switch 200 has been illustrated as a network device in the second embodiment, a management server 100 may similarly manage other types of network devices. Details are as follows.

For example, a server computer having a load distribution function, a firewall function, or the like may be provided between the networks 10 and 20 or in a network 10. In this case, the server computer may be referred to as a network device. A plurality of tenants may be allowed to change the configuration in the configuration file for at least any one of the load distribution function, the firewall function, and the like of the server computer.

For example, a blade server 600 may be provided between the networks 10 and 20. The blade server 600 accommodates a plurality of devices called blades each including a processor and a RAM, and operates an OS and a virtual machine in units of blades. The blade server 600 includes blades 610 and 620 and a switch blade 630.

The blade 610 includes a hypervisor 611 and firewalls 612 and 613. The hypervisor 611 operates a virtual machine using resources such as a processor and a RAM of the blade 610. Software is executed to realize the hypervisor 611. The hypervisor 611 includes a virtual switch 611a. The virtual switch 611a provides a function of relaying data communication of the virtual machine running on the blade 610. The firewalls 612 and 613 operate on the hypervisor 611, and block predetermined access to the network 10. The firewalls 612 and 613 may operate on the virtual machine.

The blade 620 includes a hypervisor and a virtual machine as with the blade 610. For example, the blade 620 may realize a load distribution function or a firewall function using the virtual machine. The switch blade 630 is a switch relaying data communication of the blades 610 and 620.

Thus, the load distribution function or the firewall function may be realized by the blade server 600. In this case, the blade server 600 may be referred to as a network device. Even when the virtual switch 611a, the firewalls 612 and 613, and the switch blade 630, for example, are shared among a plurality of tenants and each tenant is allowed to change a configuration in a configuration file for each function, the management method by the management server 100 is applicable.

The same applies to other network devices. For example, a plurality of tenants may share a load distribution device 700 provided in the network 10 and each tenant may be allowed to change a configuration of the load distribution device 700. Specifically, each tenant may be allowed to change a configuration, such as a correspondence relationship between a plurality of actual IP addresses on servers 300, 300a, and 300b and virtual IP addresses on the load distribution device 700, in the configuration file of the load distribution device 700.

The network device may be, for example, an L3 switch, a router, a firewall device, an intrusion detection system (IDS) device, an intrusion prevention system (IPS) device, and a unified threat management (UTM) device. For example, each tenant may be allowed to change a configuration in the configuration file of each device, for a rule of screening traffic which is permitted to be communicated or a rule of detecting unauthorized access for these devices.

When a plurality of network devices are managed, the management server 100 holds a configuration file group, a management table, and a restriction table for each network device to be managed in the storage unit 110. For example, the management server 100 may hold these pieces of information in association with identification information of the network device.

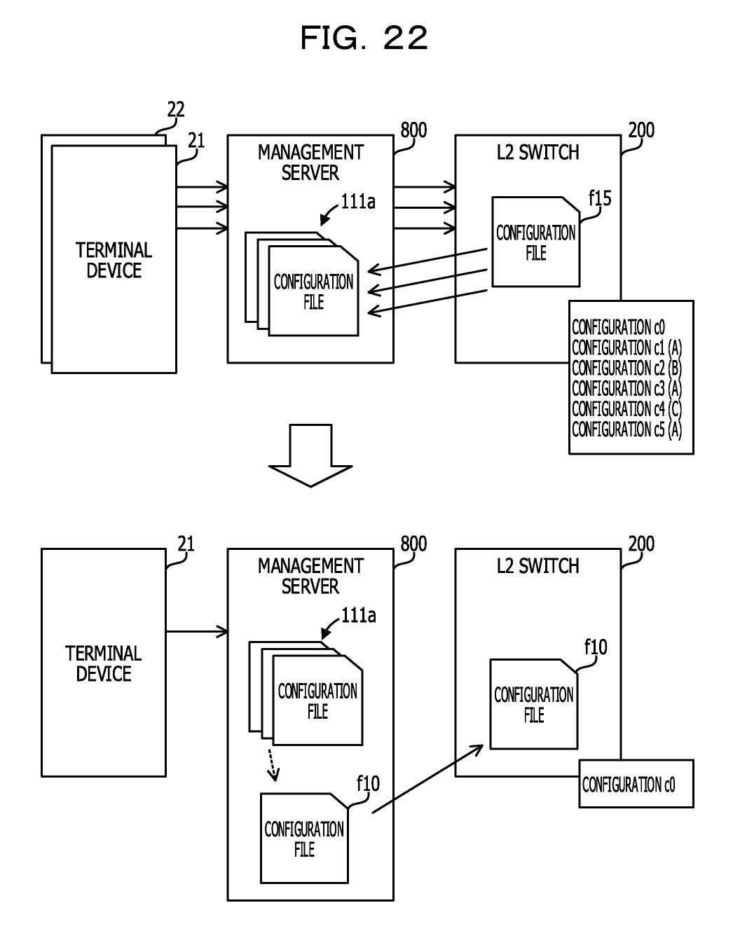

FIG. 22 is a diagram illustrating a comparative example of a restoration process. With reference to FIG. 22, a case in which the restoration method according to the second embodiment is not used will be described as the comparative example. Here, a server computer used for a process of the comparative example is assumed to be a management server 800. The information processing system assumed in FIG. 22 is similar to the information processing system illustrated in FIG. 2. In FIG. 22, a sign indicating a tenant or an administrator that has performed a configuration change is attached as in FIG. 15 (for example, “(A)”).

For example, the management server 800 acquires a configuration file from an L2 switch 200 each time the management server 800 receives a request to set the L2 switch 200 from, for example, a terminal device 21 or 22, and adds the configuration file to a configuration file group 111a. Here, the current latest generation is a generation K+5, and a configuration file of the generation K+5 is a configuration file f15. As other configuration files, the management server 800 holds configuration files f10, f11, f12, f13, and f14 (corresponding to generations K, K+1, K+2, K+3, and K+4 in this order). Content of configuration of each configuration file is as illustrated in FIGS. 5 to 7.

For example, the management server 800 receives a request for restoration to the generation K from the terminal device 21 (tenant A). In this case, the management server 800 may perform a configuration of the L2 switch 200 by acquiring the configuration file f10 from the configuration file group 111a and inputting the configuration file f10 to the L2 switch 200. However, the configuration c2 by tenant B and the configuration c4 by the administrator are not contained in the configuration file f10, as described above. Therefore, when the L2 switch 200 is set with the configuration file f10, the configuration c2 by tenant B and the configuration c4 by the administrator performed after the generation K are invalidated.

Therefore, the management server 100 searches for the configuration change by another tenant or the administrator that has been performed after the restored generation K, and generates a configuration file for restoration by reflecting the searched configuration change in the configuration file f10. The management server 100 inputs the generated configuration file to the L2 switch 200 and performs the configuration of the L2 switch 200. Accordingly, the configuration of the L2 switch 200 is restored up to the generation K for tenant A. On the other hand, the configurations c2 and c4 of the L2 switch 200 performed after the generation K may be maintained for tenant B and the administrator. While the case in which the number of the tenants and administrator is 3 has been illustrated in the above description, the similar process may be performed when the number is equal to or greater than 4.

As described above, according to the management server 100, when the network device is shared among a plurality of tenants, it is possible to freely restore the configuration of the network device for each tenant while guaranteeing independence between the tenants.

The information processing in the first embodiment may be realized by causing a processor used as the calculation unit 1b to execute a program. The information processing of the second embodiment may be realized by causing the processor 101 to execute a program. These programs may be recorded in the computer-readable recording medium 13.

For example, a program may be distributed by distributing the recording medium 13 having the program recorded therein. The program may be stored in another computer and distributed over a network. The computer, for example, may store (install) the program recorded in the recording medium 13 or the program received from another computer in a storage device such as the RAM 102 or the HDD 103, read the program from the storage device, and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management device, comprising:
a storage unit; and
a processor configured to
store, when configuration information is updated by one client of a plurality of clients, the updated configuration information, generation information on a generation of the updated configuration information, and identification information of the one client in association with one another in the storage unit,
generate, when restoration to a first generation is requested by a first client of the plurality of clients, new configuration information with reference to information stored in the storage unit, the new configuration information not including first contents of first updates made by the first client in second generations later than the first generation and including second contents of second updates made in the second generations by second clients of the plurality of clients, the second clients being different from the first client, and
perform a configuration of a network device using the new configuration information.

2. The management device according to claim 1, wherein the processor is configured to
select, based on a comparison between a first number of the first updates and a second number of the second updates, whether to generate the new configuration information by reflecting the second contents in first configuration information corresponding to the first generation or by removing effects of the first contents from second configuration information corresponding to a latest generation.

3. The management device according to claim 1, wherein
the processor is configured to
distinguish between the first updates and the second updates on basis of the identification information and the generation information stored in the storage unit in association with corresponding configuration information.

4. The management device according to claim 1, wherein
the storage unit is configured to store therein restriction information on a restriction to be satisfied by configuration information of the network device, and
the processor is configured to
determine whether the new configuration information satisfies the restriction with reference to the restriction information stored in the storage unit,
perform the configuration of the network device using the new configuration information when the new configuration information satisfies the restriction, and
notify, when the new configuration information does not satisfy the restriction, the first client that the restoration to the first generation is not performed, without performing the configuration of the network device using the new configuration information.

5. A computer-readable recording medium having stored therein a program for causing a computer to execute a process, the process comprising:
storing, when configuration information is updated by one client of a plurality of clients, the updated configuration information, generation information on a generation of the updated configuration information, and identification information of the one client in association with one another in a storage unit;
generating, when restoration to a first generation is requested by a first client of the plurality of clients, new configuration information with reference to information stored in the storage unit, the new configuration information not including first contents of first updates made by the first client in second generations later than the first generation and including second contents of second updates made in the second generations by second clients of the plurality of clients, the second clients being different from the first client; and
performing a configuration of a network device using the new configuration information.

6. A method of managing configuration information of a network device, the method comprising:
storing by a computer, when configuration information is updated by one client of a plurality of clients, the updated configuration information, generation information on a generation of the updated configuration information, and identification information of the one client in association with one another in a storage unit;
generating, when restoration to a first generation is requested by a first client of the plurality of clients, new configuration information with reference to information stored in the storage unit, the new configuration information not including first contents of first updates made by the first client in second generations later than the first generation and including second contents of second updates made in the second generations by second clients of the plurality of clients, the second clients being different from the first client; and
performing a configuration of the network device using the new configuration information.
